(19) United States
(12) Patent Application Publication
(10) Pub. No.: US 2011/0068022 A1
(43) Pub. Date: Mar. 24, 2011

(54) Storage / Display Unit

(76) Inventors: H. William Koch, III, Scarborough, ME (US); Sandra M. Koch, Scarborough, ME (US)

(21) Appl. No.: 12/939,572

(22) Filed: Nov. 4, 2010

Related U.S. Application Data
(63) Continuation-in-part of application No. PCT/US09/43005, filed on May 6, 2009.

(51) Int. Cl. B65D 77/00; F16M 13/02

(52) U.S. Cl. 206/216; 248/224.8

(57) ABSTRACT

A storage/display unit that is mountable on a support column is disclosed. The walls provide an enclosed storage space and may have one or more apertured walls for receiving and supporting pegboard or slatboard accessories. The storage/display unit has mounting means that allows it to be mounted on a support column, such as a lally column. The mounting means may be such, that it surrounds the circumference of a support column, or have a rear wall that allows the unit to be fitted against only a portion of the support column. The rear wall may have a column adapter and means for accommodating the various diameters of round support columns. The unit may also be mounted on a flat wall or used as a stand-alone unit.

This application claims priority from provisional application 61/126,807, filed on 7 May 2008, and PCT application PCT/US2009/43005, filed on 6 May 2009.

### BACKGROUND OF THE INVENTION

1. Field of the Invention

The present invention relates generally to storage devices that are constructed at least partially of pegboard or slatboard.

2. Description of the Prior Art

Storage and display space is highly valued, both in commercial ventures and in homes. Over the years, pegboard, slatboard or slotboard, and slatwall or slotwall have proven to be very versatile storage means and a wide variety of item-mount devices for securing articles to the pegboard or slatboard have been devised, to be used in conjunction with pegboard or slatboard for storing or displaying articles for sale, tools, etc. Pegboard has rows and columns of evenly spaced through-holes into which conventional item-mount devices, such as, for example, pegs, hooks, S-hooks, J-bolts, U-bolts, prongs, holders, and other accessories are inserted. The pegboard is typically mounted on a flat wall, spaced a certain distance from the wall to allow the conventional item-mount device to be inserted into a hole so as to be braced against the back side of the pegboard, without interference from the wall. Being mounted on a wall, only one surface of the pegboard is available to serve as a storage surface.

Pegboard was initially constructed as a flat rigid board of plywood or fiberboard, but today may be made of wood, wood fiber, plastic materials, hard rubber, metal, or any other material that has the necessary strength and rigidity to support tools or goods suspended from the conventional item-mount devices that are inserted into the through-holes. For this reason, pegboard is not suitable for mounting on surfaces that are curved, such as on support columns or similar structural elements.

Conventional slatboard or slatwall, also referred to as “slotboard” or “slotwall”, is a rigid panel having evenly spaced horizontal grooves that receive conventional support devices, such as hooks, prongs, or other devices. Slatwall is commonly used in stores, to display goods for sale suspended on the conventional slatboard or slatwall item-mount devices. As with pegboard, slatwall is unsuitable for mounting on curved surfaces, because of its rigidity.

Support columns, such as lally columns, posts, I-beams, etc., are very common structural elements in commercial and residential areas. Generally, such columns provide no utility other than the structural support function. Such columns are typically installed at regular intervals in large open spaces, such as are found in stores, warehouses, garages, and basements of residential structures, yet are unusable for display or storage purposes. Basements and garages in residential buildings frequently have support columns, known as lally columns. “Big box” stores have large support columns. These columns not only break up what would otherwise be useful space for display or storage racks or cabinets, but they are also often unsightly. Often, such support columns are cylindrical in shape and are, therefore, unsuited for supporting conventional storage and display units. As a result, premium display area remains underutilized.

What is needed is a storage unit that provides a storage or display surface that accepts conventional pegboard and slatwall item-mount devices and that is mountable on a wall or a support column, including a cylindrical support column. What is further needed is such a storage unit that provides an enclosed storage space.

### BRIEF SUMMARY OF THE INVENTION

The invention is a storage/display unit comprising walls or panels to form an interior and enclosed storage space. At least one of the walls or a portion of one of the walls includes an apertured wall, which has apertures that allow items to be displayed or stored on the wall, either on the outside or inside surfaces, by means of conventional pegboard or slatboard item mounts, such has pegs, hooks, prongs, etc. The apertured wall or panel may be constructed of conventional pegboard, slatboard, slotboard, slatwall, or slotwall panels and the term “apertured wall” used hereinafter in the following description shall encompass pegboard, slatboard, slotboard, slatwall, and slotwall. The term “item-mount device” shall refer to devices for mounting tools or displaying items, etc. on conventional pegboard, slatboard, etc. Such item-mount devices include, but are not limited to, pegs, hooks, prongs, clamps, bins, trays, straps, loops, etc. Each of the walls may be constructed as an apertured wall, or, depending on the particular intended use of the storage/display unit, only selected walls or portions of walls may be apertured. For example, the side walls may be constructed of pegboard and the top and bottom walls constructed of a solid material, to allow the top and/or bottom wall to serve as a shelf or a base. Alternatively, the top and bottom walls may also be apertured, so as to receive and support item-mount devices. A portion of one or more of the apertured walls may also include grooves for receiving slatwall hooks or other slatwall accessories.

The storage/display unit has an access means for gaining access to the enclosed space, i.e., to the interior space of the unit. The access means may be an opening in one of the walls, or may be a drawer, a door, or a movable panel mounted on one of the walls. The enclosed space may serve as a cabinet. In other words, the enclosed space may be used to store items by suspending them from the internal surfaces of the apertured walls, thereby increasing the storage capability of the storage/display unit. Items may be suspended from the top, bottom, or side walls by means of conventional item-mount devices, or simply placed for storage on the bottom wall that serves as a base.

The storage/display unit according to the invention may be mounted on a building wall or on a support column, either as a unit that surrounds the support column or a unit that has a curved wall to mount against an area of the support column that encompasses only a partial circumference. If the unit surrounds the support column, an appropriately dimensioned opening is provided in the top and bottom walls. A friction collar may be provided on the mounting surface of the unit for gripping the support column to prevent slippage. Clamping or tensioning means may be used to securely mount the unit on the column.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a perspective view of the storage/display unit according to the invention, mounted on a support column.

FIG. 2A is a plan view of a side wall.

FIG. 2B is a cross-sectional view of the side wall of FIG. 2A, showing the male snap connectors for insertion into corresponding female receivers in the top and bottom walls.

FIG. 2C is a cross-sectional view of the side wall of FIG. 2A, showing the snap connections for the side walls.

FIG. 3A is a plan view of a top or bottom wall of the storage/display unit of FIG. 1.

FIG. 3B is a plan view of a shelf.

FIG. 4 is a top plan view of the storage/display unit, assembled about a support column, illustrating insertion of the slide lock in the top wall.

FIG. 5 is a top plan view of the slide lock assembled in a top wall.

FIG. 6 illustrates slide grooves in a top or bottom wall for receiving the slide lock.

FIG. 7 is a perspective view of a second embodiment of the storage/display unit according to the invention, the unit having two half units that are mated together to form a complete enclosure.

FIG. 8 is a perspective view of a third embodiment of the storage/display unit according to the invention, mounted on a support column.

FIG. 9 is a plan view of the walls of the storage/display unit of FIG. 8, prior to assembly.

FIG. 10 is a perspective view of a fourth embodiment of the storage/display unit according to the invention, using snap-fit buttons to connect the various walls.

FIG. 11 illustrates the snap-fit button connection.

FIG. 12 illustrates a storage/display unit comprising four wedge-shaped components.

FIG. 13 illustrates a storage/display unit that is elliptical in shape.

FIG. 14 illustrates the storage/display unit according to the invention mounted to a stud wall.

FIG. 15 illustrates a plug inserted into a column opening to provide a solid surface.

FIG. 16 is a perspective view of the storage/display unit according to the invention, showing serrated gripping edges on the attachment collar and embossed knockouts for accommodating various post diameters and shapes.

FIG. 17 is a top plan view of the storage/display unit of FIG. 16.

FIG. 18 is an elevation view in section of the storage/display unit of FIG. 16, showing the enclosed storage space.

FIG. 19 is an exploded perspective view of the storage/display unit according to the invention, showing a non-circular shape and attachment to a non-circular column.

FIG. 20 is an exploded perspective view of the storage/display unit according to the invention, showing an base immovably and a platform rotatably mounted on the column.

FIG. 21 is a perspective view of the storage/display unit of FIG. 20, with the rotatable platform inverted to position the compartmented side upwardly.

FIG. 22 is an elevation view in section of the storage/display unit of FIGS. 20 and 21, showing a mating interlocking means.

FIG. 23 is a top plan view of the storage/display unit according to the invention, showing a hinge at one side and a pinch bolt at the opposite side for mounting the storage/display unit to the column.

FIG. 24 is an elevation view in section of another alternative embodiment of a column attachment according to the present invention comprising unitary portions of a platform that attaches directly to the column using circumferential clamps or frictional ties.

FIG. 25 is an elevation view of the storage/display unit according to the invention, showing a platform with various attachment passages in the outer wall and a series of raised protrusions along the upper edge of the wall.

FIG. 26 is a top plan view of the storage/display unit according to the invention, showing telescoping sidewalls.

FIG. 27 is a top plan view of the storage/display unit, showing a rear wall with a column adapter and ways of mounting the unit on round columns of various diameters.

FIG. 28 is a perspective view of the rear wall of the storage/display unit shown in FIG. 27, showing compression means and mounting means.

FIG. 29 is a perspective view of the rear wall of the storage/display unit shown in FIG. 27, showing compression means and mounting means with a bracket.

FIG. 30 is a top plan view of the storage/display unit of FIG. 27, showing the unit attached to a column with the mounting means.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

The present invention relates to various embodiments of a storage/display unit for providing external and internal storage and display space for tools, articles of manufacture, etc. The storage/display unit according to the invention is constructed to be mounted on a support column, such as a lally column or other column that is conventionally used in the residential and commercial buildings, or on a flat wall, or be used as a stand-alone unit resting on a support surface. Preferred embodiments of the storage/display unit include one or more wall constructed of an apertured material, such as pegboard or slatboard, although it is understood that the walls may be constructed of solid panels.

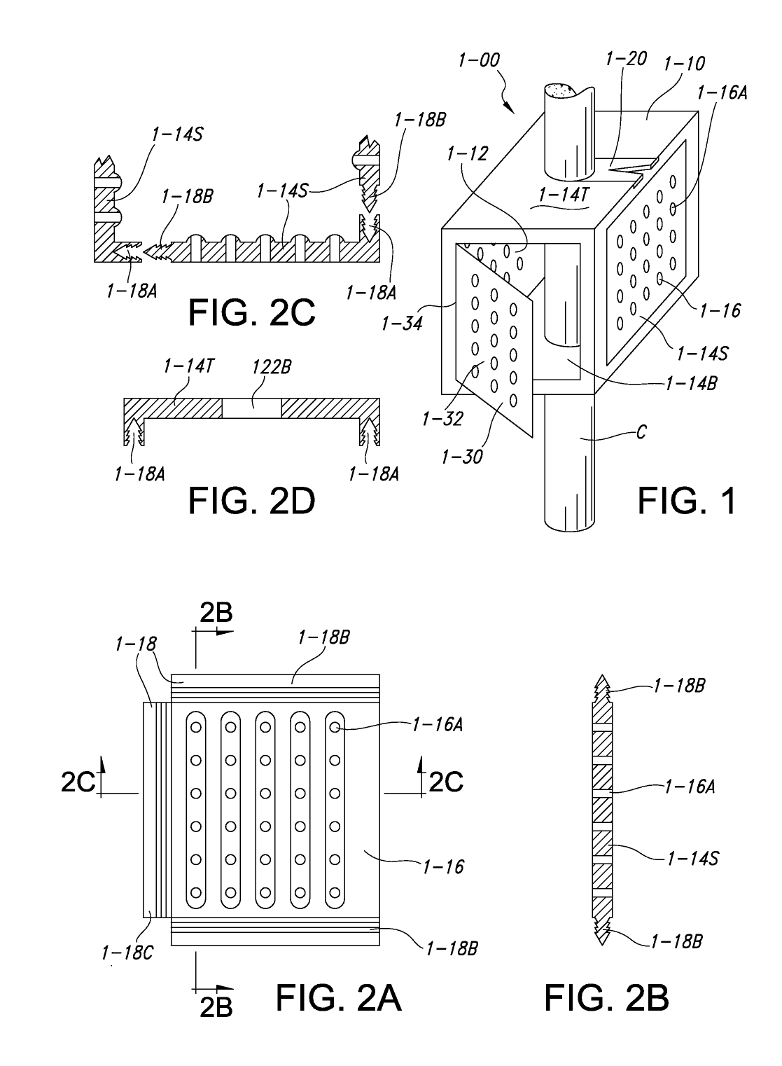

FIG. 1 illustrates a first embodiment of a storage/display unit 1-100 according to the invention, which comprises a storage enclosure 1-10 having an interior storage area 1-12, mounting means 1-20, and access means 1-30 for providing access to the interior storage area 1-12. Not shown in this illustration are various conventional item-mount devices, such as pegs, hooks, bolts, prongs, bins, straps, tool holders, etc., which may be used to support various items, such as tools or articles of manufacture, on the storage/display unit 1-100.

The storage enclosure 1-10 comprises a plurality of walls 1-14, which, in this embodiment, include side walls 1-14S, a top wall 1-14T, and a bottom wall 1-14B. At least a portion of one or more of the walls 1-14 may be an apertured wall 1-16, i.e., a wall with apertures for receiving conventional pegboard or slatboard item-mount devices. In the embodiment shown in FIG. 1, the bottom wall 1-14B and the top wall 1-14T are constructed of a solid material, although, depending on the intended application, these walls, too, may be constructed as an apertured wall. Materials that may be used to construct the apertured wall 1-16 include pegboard or slatboard and variations thereof.

FIGS. 2A-2D illustrate one embodiment of a connector 1-18 that is suitable for easily and securely fastening the walls 1-14 to each other. Numerous devices and configurations may serve as the wall connector 1-18, such as, but not limited to, a snap or pawl connector, a connector based on a friction or interference fit, a locking connector, a threaded connector, acorn or button fasteners, etc. In the embodiment shown in FIGS. 2A-2D, the wall connector 1-18 is a snap-fit connector that includes mating ribbed or ridged male and female connectors 1-18B and 1-18A, respectively. The wall connector 1-18 on the upper and lower edges of the side walls 1-14S is a ribbed male connector 1-18B for insertion into mating ribbed female connectors on the top wall 1-14T and the bottom wall 1-14B, respectively. The vertical edges of the side walls 1-14S have male and female connectors 1-18B and 1-18A that form a corner connection with an adjacent side wall. FIG. 2C is an exploded sectional view, showing the mating connections between one side wall and two adjacent side walls. FIG. 2D shows a top wall 1-14T, constructed similarly to the lid of a conventional shoe box, having female connectors 1-18A for receiving the male connectors 1-18B of the vertical side walls 1-14S. The bottom wall 1-14B is constructed similar to the top wall 1-14T. In the embodiment shown in FIGS. 2A-2C, reinforcing ribs 1-15 are provided on at least one face of the wall 1-14S, because it is an apertured wall 1-16. The reinforcing ribs 1-15 may not be necessary and may be eliminated, in which case the faces of the walls 1-14S are constructed with a uniform thickness. This, of course, depends on the material used to construct the apertured wall 1-14 or on the intended use of the storage/display unit 1-100.

The access means 1-30 in the embodiment shown is a door 1-32 and a hinge 1-34. The hinge 1-34 may be a pintle hinge or a live hinge. The access means 1-30 may, however, be a some other suitable type of access means, such as, a flap, a sliding panel, or a simple opening provided in one of the walls 1-14.

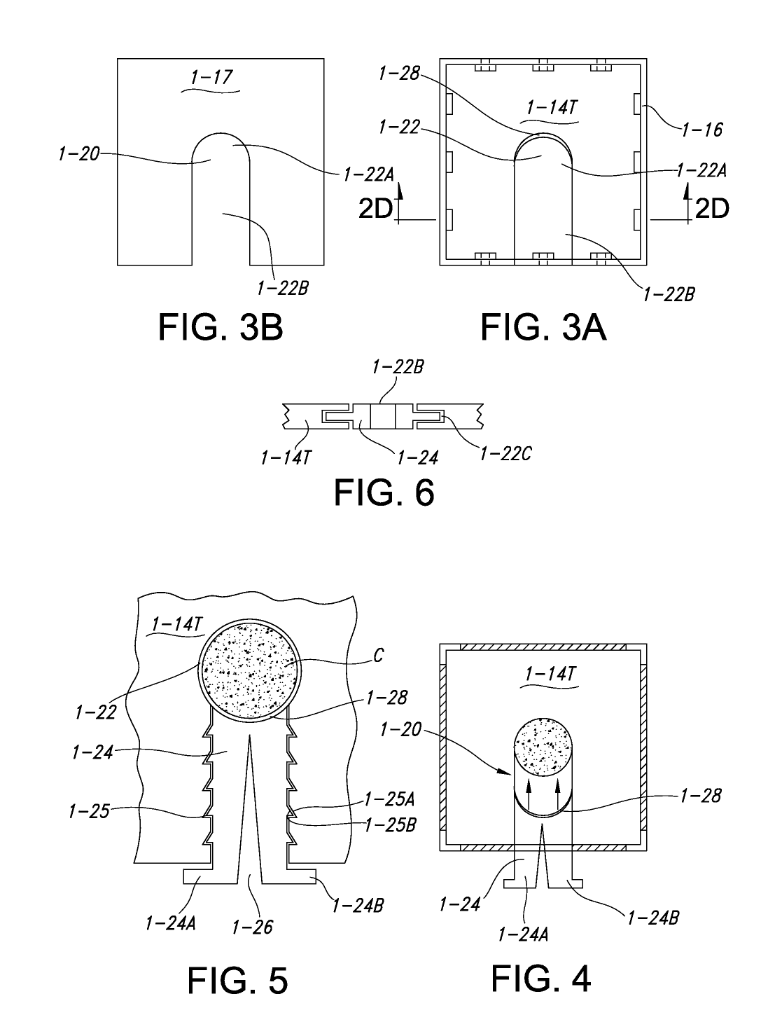

FIGS. 3A-6 illustrate one embodiment of the mounting means 1-20 for the particular embodiment shown in FIG. 1, which is intended to be mounted on support column C. FIG. 3A illustrates a plan view of the top or bottom wall 1-14T, 1-14B respectively. The mounting means 1-20 includes an opening 1-22 that allows the top and bottom walls 1-14T, 1-14B to fit around the support column C. The opening 1-22 includes,a column opening 1-22A, which is dimensioned to fit snugly against the perimeter of the support column C, and an assembly opening 1-22B, which allows the top wall, bottom wall 1-14T, 1-44B, to be assembled onto the side walls 1-14S, which have been assembled around the support column C. FIG. 6 illustrates grooves in the edges 1-22C of the assembly opening 1-22B for receiving a slide lock 1-24. The slide lock 1-24 has a friction lip 1-28 that fits-against the contour of the support column C. The friction lip 1-28 may be integrally formed with or affixed to the slide lock 1-24. Examples of suitable materials for the friction lip 1-28 include silicone, rubber, and neoprene. The column opening 1-22A may also have a friction lip 1-28. This list of materials is merely illustrative of the types of materials that may be used and is not intended to be limiting. In this particular embodiment, the slide lock 1-24 has tensioners 1-24A and 1-24B. When mounting the storage/display unit 1-10 on the support column C, the unit 1-100 is brought into the desired position and the slide lock 1-24 inserted and pushed against the support column. The friction lip 1-28 prevents the storage/display unit 1-100 from slipping on the support column C. The tensioners 1-24A and 1-24B provide a sideward thrust on the top or bottom wall, which increases the friction against the wall and prevents the slide lock 1-24 from inadvertently slipping out of the assembly opening 1-22B. As shown in FIG. 6, mating locking ridges 1-25A and 1-25B, respectively, may be provided on the wall 1-14 that receives the slide lock 1-24 and on the slide lock 1-24. The slide lock 1-24 is inserted into the receiving grooves on the top wall 1-14T or on the bottom wall 1-14B, as the case may be. The tensioners are released, and the locking ridges 1-25B on the slide lock 1-24 snap into the mating locking ridges 1-25A.

FIG. 3A is also illustrative of a shelf 1-17 that is insertable into the interior storage area 1-12. This is particularly advantageous, when a tall storage/display unit is intended to be installed on a support column. The shelf 1-17 is narrower than the top and bottoms walls, so that it fits easily within the interior storage area 1-12. The mounting means 1-20 that is provided in the top and bottom walls of the particular storage/display unit is also provided in the shelf 1-17. In this embodiment, the support column opening 1-22A and the assembly opening 1-22B are provided in the shelf 1-17, which is then assembled in the interior storage area 1-12. The shelf 1-17 provides additional support surface for storage within the interior storage space and also provides additional means of securing the storage/display unit to the support column. For example, it may be beneficial to provide such shelves 1-17 at intervals, to more securely mount the tall storage/display unit on the support column C.

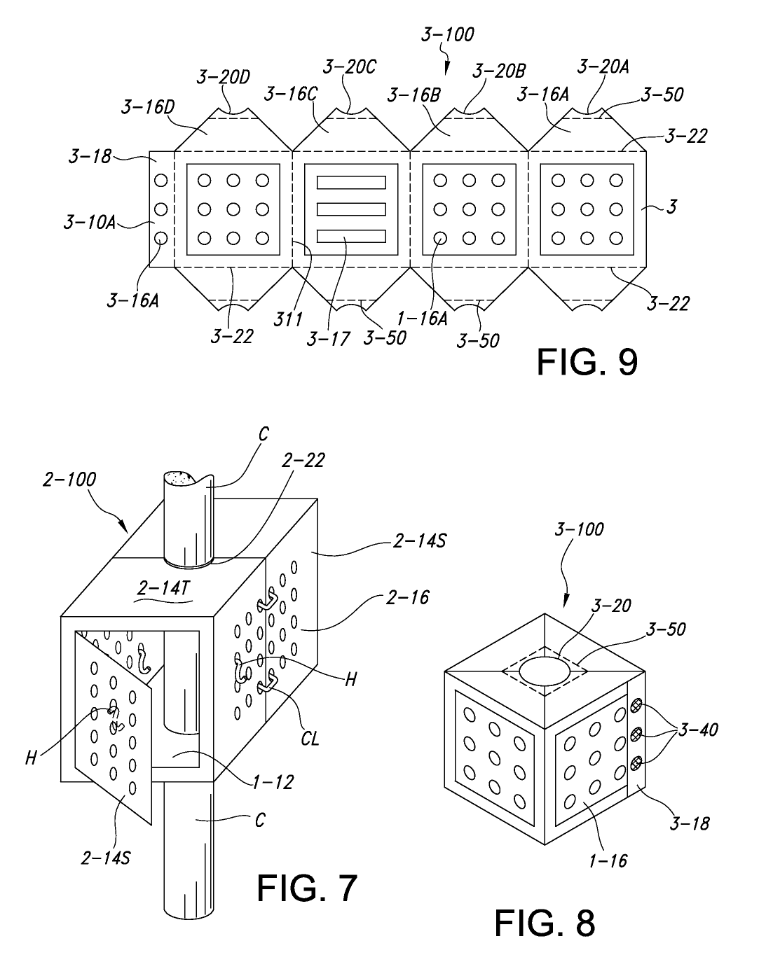

FIG. 7 illustrates a second embodiment of a storage/display unit 2-100 according to the invention. This embodiment is very similar to the first embodiment, providing the same inner storage area 1-12 and being mounted on the support column C. The storage/display unit 2-100 is a storage enclosure 2-10 constructed of two half units 2-20 that are fastened to each other by a fastening means 2-40. In this embodiment, the two half-units 2-20 have mating male/female edges, such that the open perimeter of a male half-unit 2-20A fits within the open perimeter of a female half-unit 2-20B. The material for the walls 1-14S, or at least the open edges of the walls, may be selected to be slightly flexible to provide a friction fit between the two half units 1-20. To secure the two half-units 2-20 to each other, conventional pegboard clamps CL are inserted into pegboard holes 2-16A on either side of the mating edges, as shown in FIG. 7. For purposes of illustration, conventional item-mount devices H are shown inserted into a pegboard hole 2-16A on the outside face and on the inside face of the side walls 2-14S. The hooks are representative of any of the many conventional item-mount devices and supports that may be mounted on the apertured wall 2-16. Top walls 2-14T each have a column opening 2-22 that is dimensioned to fit snugly against the perimeter of the support column C. A friction lip 2-28 may also be provided on the edge of the column opening 2-22 to prevent the storage/display unit 2-100 from slipping on the support column C.

FIGS. 8 and 9 illustrate a third embodiment 3-100 of the storage/display unit according to the invention. In this embodiment, walls 3-14 are formed on a unitary sheet 3-10 of a flexible material. An overlap 3-18 at a first end 3-10A of the unitary sheet 3-10 overlaps with a second end 3-10B. Pegboard holes 3-16A in the overlap 3-18 can thus be brought into a position congruent with pegboard holes 3-16A at the second end 3-10B. Insertion of pegs or other conventional item-mount devices 3-40 serves to hold the unitary sheet 3-10 in a wrapped configuration that forms the storage enclosure 3-10. In the embodiment shown here, the item-mount device is simply a button with a ridged post. As with the first embodiment, access means 3-30 into the enclosure 3-10 may simply be an opening in one of the walls 3-14, or a sliding panel, but may also include a door 1-32 and a hinge 1-34, as shown in FIG. 1.

The unitary sheet 3-10 shown in FIG. 9 also includes flaps 3-16 that fold together to form mounting means 3-20. In the embodiment shown, a series of four flaps 3-16A-3-16D are integrally connected to the walls by means of a living hinge 3-22 that extends along the top and bottom edges and that allows the flaps 3-16 to bend relative to the plane of the walls 3-14. Each of the flaps 3-16 has a sectional cutout 3-20A-3-20D. To assemble the storage/display unit 3-100, the flaps 3-20 are folded inward at a 90-degree bend. The series of cutouts 3-20A-3-20D forms the column opening 3-22 that is dimensioned to fit up against the perimeter of the support column C. Here, too, each of the section cutouts may have a friction lip 3-28, to secure attachment of the storage/display unit 3-100 to the support column C.

The unitary sheet 3-10 shows grooves 3-17 that may be provided on one or more of the walls 3-14 for receiving slatwall hooks. The grooves 3-17 are evenly spaced and extend in the horizontal direction. This representation illustrates that grooves 3-17 as well as pegboard 3-16 may be used for the walls 1-14, 2-14 or 3-14 shown in these first three embodiments or for any walls in the subsequent embodiments. The number of side walls for this unitary-sheet construction is not limited to four, as shown in FIG. 9, but instead, may be any suitable number, for example, three, five, six, etc. The section cutout 3-20 on the flap 3-16 must, of course, be correspondingly adjusted to the total number of flaps 3-20 to form a contour that fits properly around the support column C.

It is possible to construct the unitary sheet 3-10 as a sheet having varying rigidity characteristics. For example, the sheet 3-10 may have a uniform rigidity overall. The sheet 3-10 may, however, be constructed such, that the pegboard section of the walls 3-16 has a greater rigidity than the rest of the sheet 3-10. The reinforcing ribs 3-15 shown in FIG. 2 may also be used with this second embodiment. The ribs 3-15 extend in the vertical direction only and do not prevent the unitary sheet 3-10 from being flexed about a vertical axis to form the enclosure 3-10. Thus, the ribs 3-15 may be used with a unit that will have an outer contour that is circular, elliptical, rectangular, pentagonal, hexagonal, etc. Breakout grooves 3-50 may be provided in the top and bottom flaps 3-16 so as to adapt the dimension and geometry of the column opening 3-22 to the dimensions and geometry of various standard support columns C.

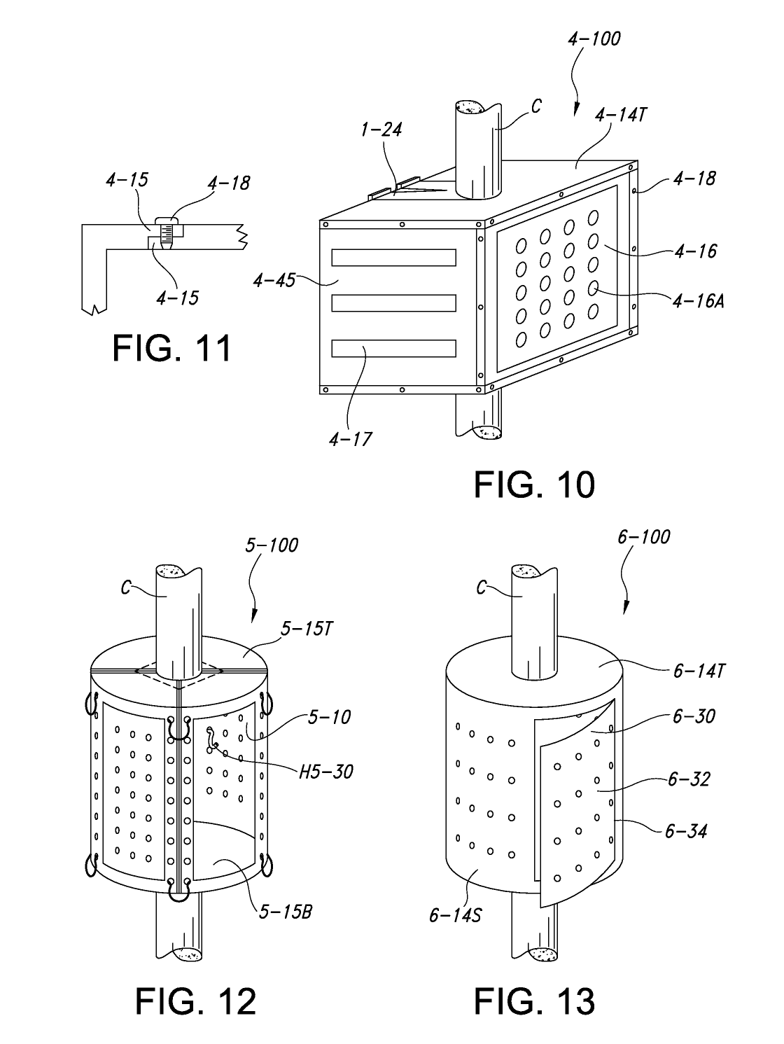

FIGS. 10 and 11 illustrate a storage/display unit 4-100 according to the invention, which is a variation of the first embodiment. The connector 4-18 is a simple button fastener. The vertical edges of the side walls 4-14S have an overlap 4-15. Pre-formed through-holes are provided in the overlaps. The through-holes align congruently when the sides are brought together for assembly and an acorn button is inserted through the holes to secure the walls to each other. The top and bottom walls 4-14T and 4-14B are dimensioned so as to fit over the perimeter of the assembled side walls 4-14S. These walls are then also fastened to the side walls 4-14S with acorn buttons.

FIG. 12 illustrates another embodiment 5-100 of a storage/display unit according to the invention, comprising multiple sectional components 5-14, although any suitable number of sectional components may be used. In the embodiment shown, the sectional component 5-14 is a cylindrical section that includes a side wall 5-15S, a top wall 5-15T and a bottom wall 5-15B. Each sectional component 5-15 has a male and a female vertical edge, such that the edges of adjacent sections overlap each other. A conventional item-mount device, such as a clamp CL, is used to secure the sectional components 5-14S to a cylindrical unit, as shown. As described in conjunction with other embodiments, an opening 5-30 may be provided in order to access an inner storage space 5-10. In this illustration, the access opening 5-30 is merely an opening in one of the sectional components 5-15S. A item-mounting device H is shown suspended in the interior storage space S-10.

FIG. 13 illustrates an elliptical shaped storage/display unit 6-100, as an illustration that the shape of the storage/display units according to the invention are not limited to any one particular shape, but can be circular, rectangular, elliptical, pentagonal, hexagonal, etc. The term “rectangular” includes square and the term “circular” includes cylindrical constructions.

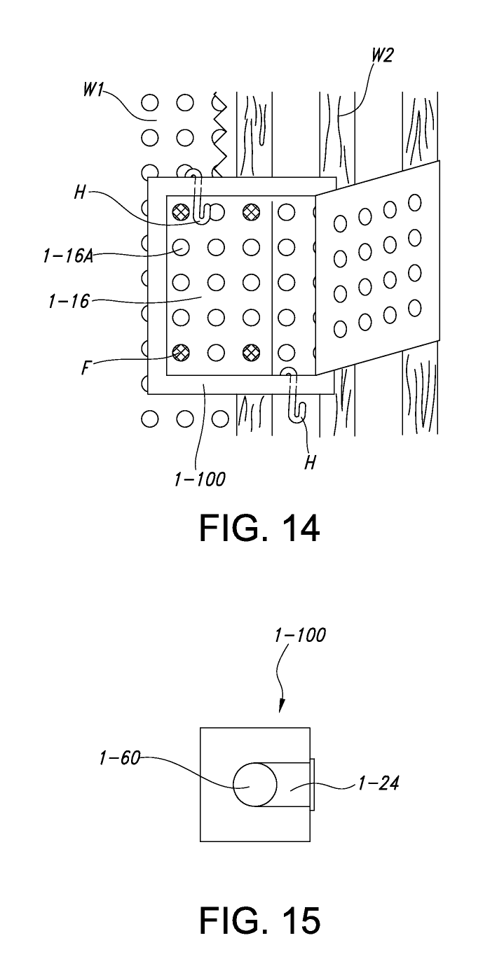

FIG. 14 illustrates a method of mounting the storage/display unit according to the invention to a structural wall. The storage/display units are not limited to being mounted on the support column C, but may be mounted on a wall or on wall studs of a structure. For units that are intended to be mounted on the wall or studs of a structure, the mounting means 1-20 or 2-20 on the top and bottom walls 1-14T, 1-14B, 2-14T, and 2-14B, respectively, may be eliminated. The storage/display unit 1-100 is shown in front plan view, mounted to a flat wall W1 or W2. Storage/display unit 1-100 is representative of any of the embodiments described herein, that have at least one flat side wall. The storage/display units may be mounted with fasteners F through apertures 16A in the apertured wall 1-16 directly onto the wall or studs W2 or also through apertures in an existing pegboard wall W1. Item-mounting devices H are shown suspended from the top and bottoms walls 1-14T, 1-14B, to illustrate that these surfaces may also be constructed of the apertured wall 1-16 and serve to support item-mounting devices.

FIG. 15 is a top plan view of storage/display unit 1-100, showing a plug 1-60 inserted into the column opening 1-22. When mounted to a wall in this manner, the column opening 1-22 is unnecessary, in which case, the column openings in the upper and bottom surfaces of the units, shown in the first four embodiments, may be eliminated or the plugs 1-60 be used to close them.

Additional components, such as pockets, protrusions may be provided on the apertured walls 1-16. Storage/display units may be stacked on top of each other. Examples of suitable materials for the storage/display units 1-100-6-100 include high density polyethylene (HDPE), low density polyethylene (LDPE), polypropylene, etc. These materials are given as suggestions only and it is not intended that this information be limiting.

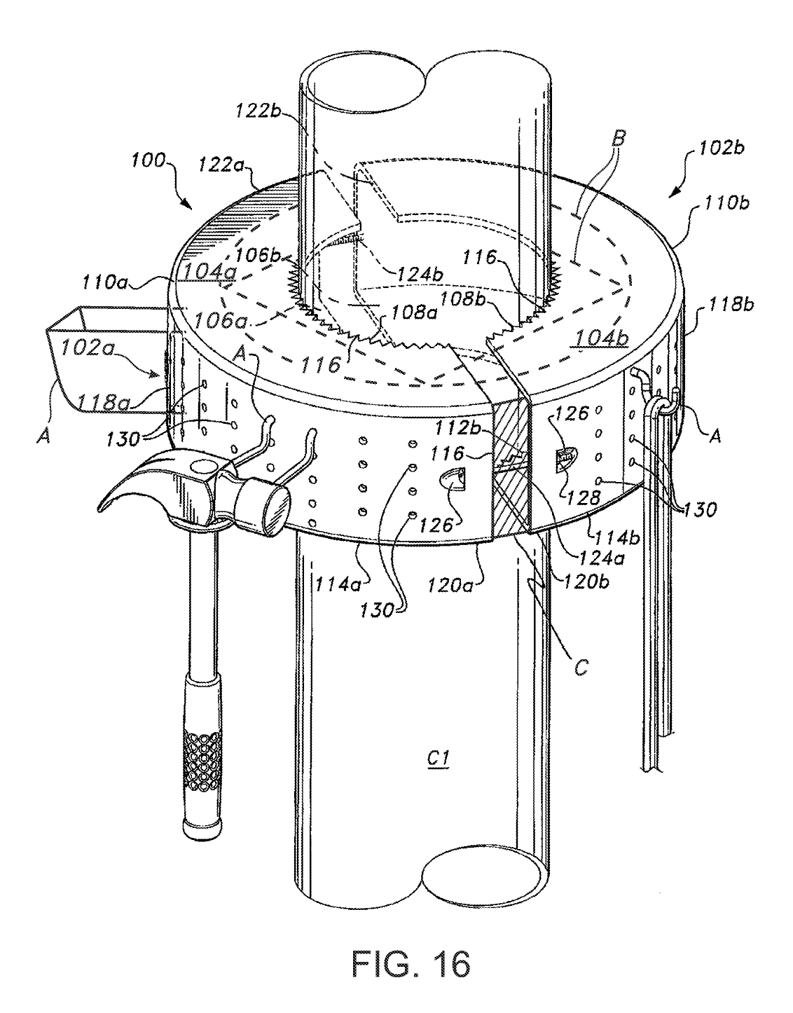

FIGS. 16-26 below illustrate various additional variations or embodiments of the storage/display unit according to the invention.

FIG. 16 is an illustration of a yet another embodiment of a storage/display unit 100 according to the invention. The storage/display unit 100 comprises opposite semicircular first and second clamp portions 102A and 102B that secure to one another and grip the column C tightly therebetween to prevent movement of the storage/display unit 100 relative to the column C. The two clamp portions 102A, 102B are preferably at least generally equal to one another in size, and preferably join to one another along a generally diametric line, although some variation in their configuration is possible, particularly in the case of non-circular columns to which the device attaches.

Each clamp portion 102A, 102B includes a generally horizontal upper flange, respectively 104A and 104B, and a generally horizontal lower flange, respectively 106A and 106B, substantially parallel to the upper flange. Each upper flange 104A, 104B has an inwardly disposed column gripping edge, respectively 108A, 108B, and an opposite outer periphery 110A, 110B. Each lower flange 106A, 106B includes a corresponding column gripping edge, respectively 112A and 112B, and outer periphery 114A, 114B. The column gripping edges 108A, 108B of the upper flange portions 104A and 104B and column gripping edges 112A, 112B of the lower flange portions 106A, 106B may include a series of column gripping teeth 116 formed therealong, to provide a better grip of the column C captured therein. A generally vertical wall, respectively 118A, 118B, joins each respective upper and lower flange to one another along their outer peripheries, i.e., the first wall 118A connects the outer peripheries 110A and 114A of the upper and lower flanges 104A and 106A, with the second wall 118B connecting the outer peripheries 110B and 114B of the upper and lower flanges 104B and 106B.

Each of the walls 118A, 118B has a first end, respectively 120A and 120B, and an opposite second end, respectively 122A and 122B. A first fastener 124A, e.g., a threaded bolt, etc., connects the first ends 120A, 120B of the two walls 118A and 118B to one another, with a second fastener 124B connecting the opposite second ends 122A, 122B of the two walls to one another. In the storage/display unit embodiment 100 of FIG. 16, each of the ends 120A through 122B of the two walls 118A, 118B includes a fastener recess 126 to allow the heads of the fasteners 124A, 124B and mating nuts 128 to lie below the cylindrical outer surface of the two wall portions 118A, 118B. This precludes the snagging or catching of some article (clothing, etc.) upon an externally protruding fastener component. The fasteners 124A and 124B and mating nuts 128 may be removed from their respective components. Alternatively, the fastener passages of one of the clamp portions, e.g., second clamp portion 102B, may be threaded, thereby precluding need for separate nuts for assembly.

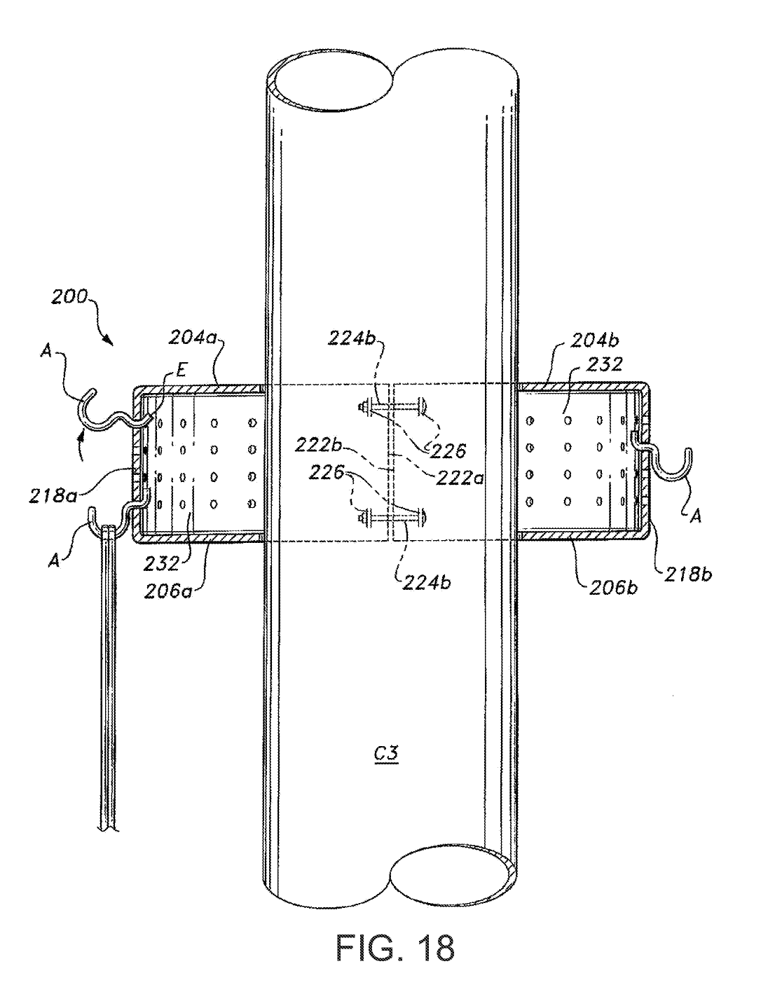

The two outer wall portions 118A and 118B each include a series of accessory attachment passages 130 formed therethrough. These accessory attachment passages provide for the removable installation of various attachments A therein, e.g., pegboard hooks for hanging extension cords, storage bins, items with straps, rope, etc. thereon, tool hangers for hanging various tools, e.g., a hammer, etc. thereon, as desired. The accessory attachment passages 130 may be in the form of small circular holes similar to those formed in pegboard, as shown in FIG. 16, or one or more horizontal slots as formed in slatboard, or a series of rectangular or square openings as formed in gridwall panels, as desired, as shown in other FIGS. The spacing of the outer walls 118A, 118B away from the inner column C to which the storage/display unit 100 is secured provides space between the walls 118A, 118B and the column C for the manipulation of the retaining ends of the pegboard hooks or other devices as required for attaching them to the outer walls 118A and 118B. This is shown most clearly in the elevation view in section of FIG. 18, and discussed further below. Embossed or stamped knockouts B for various size, shape, and diameter posts or columns C. An interior void concealing flange C is also depicted.

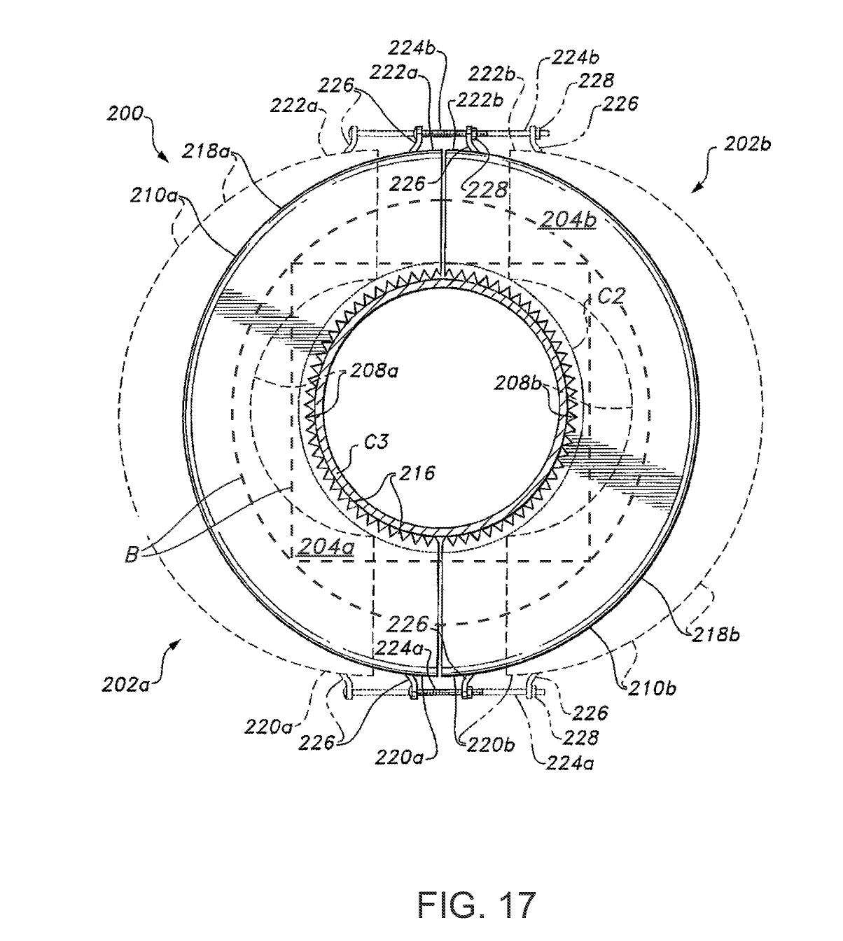

FIG. 17 provides a top plan view of a slightly different storage/display unit embodiment 200. The storage/display unit embodiment 200 differs from the embodiment 100 of FIG. 16 due to the externally protruding clamping screws or pinch bolts, as opposed to the recessed bolts of the device of FIG. 16. Otherwise, the storage/display unit 200 is essentially the same as the storage/display unit 100 of FIG. 16 and includes opposite semicircular first and second clamp portions 202A and 202B each having an upper flange, respectively 204A and 204B, with a column gripping edge, respectively 208A, 2088, and an opposite outer periphery 210A, 210B. Each lower flange, not shown in FIG. 17, but essentially the same as the lower flange portions 106A, 106B of the embodiment 100 of FIG. 16, includes a corresponding column gripping edge and outer periphery. The column gripping edges 208A, 208B of the upper flange portions 204A and 204B and column gripping edges of the lower flange portions may include a series of column gripping teeth 216 formed therealong.

A generally vertical wall, respectively 218A, 218B, joins each respective upper and lower flange to one another along their outer peripheries. Each of the walls 218A, 218B has a first end, respectively 220A and 220B, and an opposite second end, respectively 222A and 222B. A first fastener 224A passes through first and second external lugs 226 extending outwardly from the first and second walls adjacent their first ends 220A and 220B, with a second fastener 224B passing through corresponding first and second external lugs 226 extending from the walls adjacent their second ends 222A, 222B. One of each pair of lugs, e.g., the second lugs, may have an internally threaded passage to engage the corresponding fastener 224A or 224B. Otherwise, mating nuts 228 may be installed upon the threaded ends of the fasteners 224A, 224B, as in the embodiment of FIG. 16.

The top plan view of FIG. 17 clearly shows the adjustability of the storage/display unit 200. A relatively larger diameter column C2 is shown in broken lines in FIG. 17, with the inner diameter of the column gripping edges 208A, 208B being too small to grip the column C2 except at the ends of the column gripping edges 208A, 208B where they meet the respective first and second ends 220A through 222B. When longer first and second fasteners 224A and 224B are provided to correspond to the more widely spread fastener lugs 226, such a storage/display unit 200 may be installed upon a relatively larger diameter column C2. However, when a smaller column C3 is provided having a diameter substantially the same as the internal diameter defined by the column gripping edges 208A, 208B when the two clamp portions 202A and 202B are close together, as shown in solid lines in FIG. 17, more continuous contact is made between the column gripping edges 208A and 208B. So long as there is some separation between the ends 220A, 220B and 222A, 222B of the two clamp portions 202A and 202B, the column gripping edges will contact the column captured therein with at least some portions of their extent to secure the storage/display unit 200 (and related embodiments) to the column C2 or C3. Embossed or stamped knockouts B are depicted.

FIG. 18 provides an elevation view in section of the storage/display unit 200 of FIG. 17, secured about the smaller diameter column C3. This drawing clearly shows the interior volume provided by the column clamp 200 for the manipulation of the attachment ends of e.g., pegboard hooks attached thereto. The two upper flanges 204A, 204B, the opposite lower flanges 206A, 206B, and the two walls 218A, 218B, along with the central column C3 captured therein, define a toroidal accessory attachment end manipulating volume 232 therein. This volume 232 provides sufficient distance between the walls 218A, 218B and the inner column C3 to allow the attachment ends E of various accessories A, e.g., pegboard hooks as shown in FIGS. 16 and 18, etc., to be inserted through the corresponding attachment holes or passages 230 as desired without the attachment ends E being blocked by contact with the side of the column C captured therein. This theme may be extended to various shapes and configurations of pegboard storage units, different column shapes and configurations, different attachment passage configurations, etc., as shown in subsequent drawings and described further below.

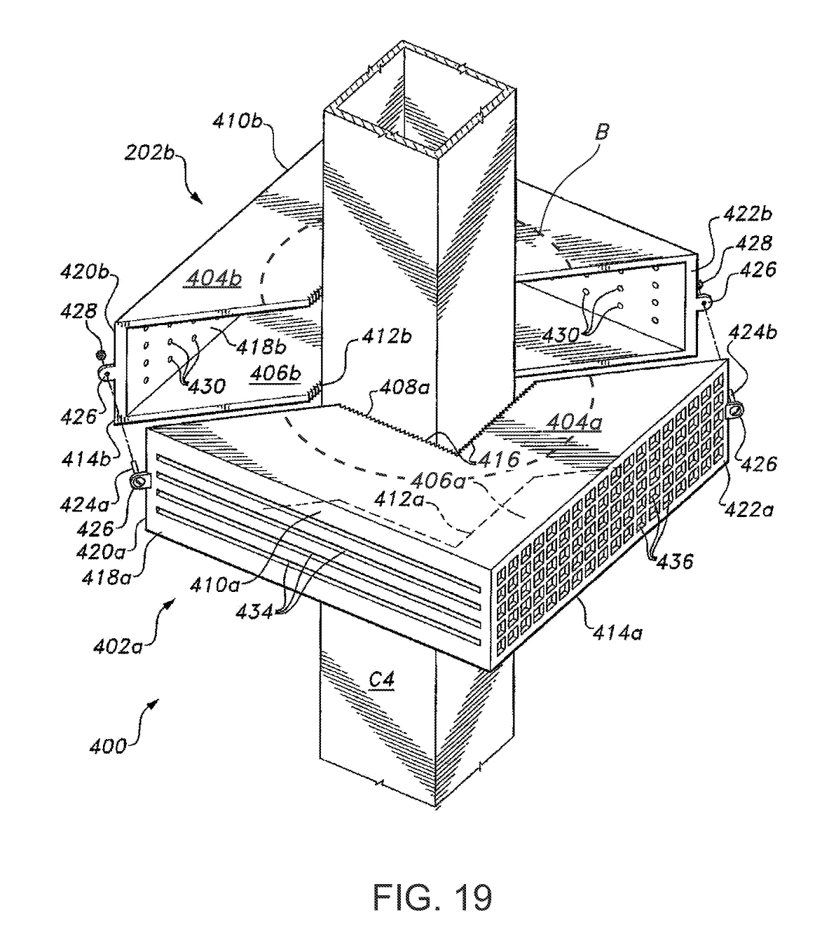

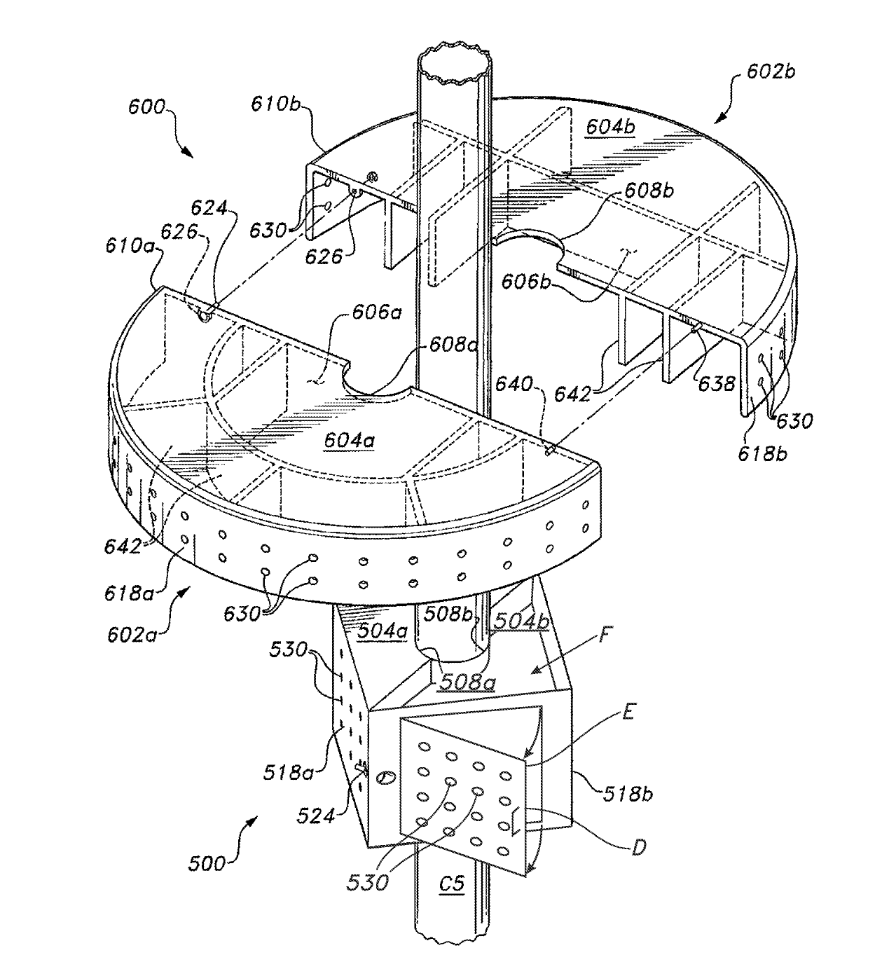

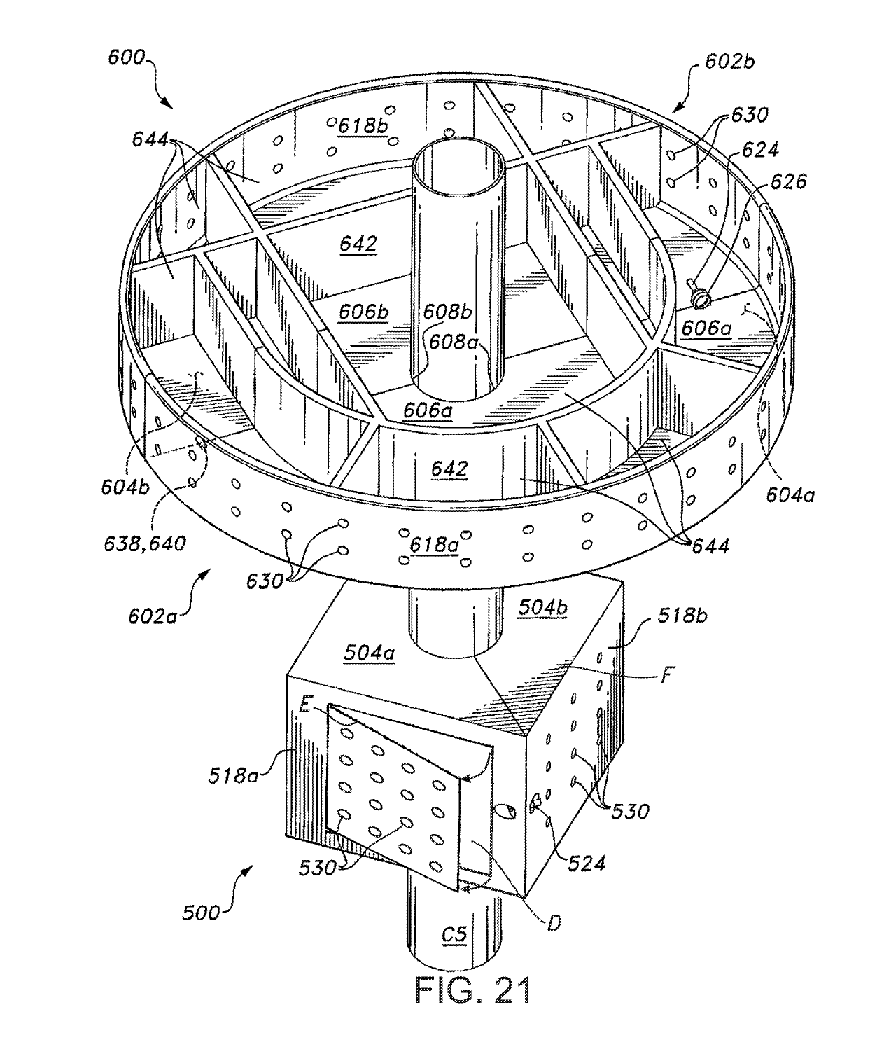

FIG. 19 illustrates one such embodiment, wherein a storage/display unit 400 having a square or rectangular planform is secured to a square or rectangular post or column C4. The storage/display unit 400 of FIG. 20 is similar to the attachments 100 and 200 of FIGS. 16 through 18, with the exception of its shape and the shape of the column C4 to which it attaches. The storage/display unit 400 also includes some alternative accessory attachment passages, as described further below. The storage/display unit 400 includes opposite first and second clamp portions 402A and 402B each having an upper flange, respectively 404A and 404B, with a column gripping edge, respectively 408A, 408B, and an opposite outer periphery 410A, 410B. Each lower flange 406A, 406B has a similar configuration to the corresponding upper flange, including a corresponding column gripping edge 412A, 412B and outer periphery 414A, 414B. The column gripping edges 408A, 408B of the upper flange portions 404A and 404B and column gripping edges 412A, 412B of the lower flange portions 406A, 406B may include a series of column gripping teeth 416 formed therealong.

A generally vertical wall, respectively 418A, 418B, joins each respective upper and lower flange to one another along their outer peripheries. Each of the walls 418A, 418B has a first end, respectively 420A and 420B, and an opposite second end, respectively 422A and 422B. A first fastener 424A passes through first and second external lugs 426 extending outwardly from the first and second walls adjacent their first ends 420A and 420B, with a second fastener 424B passing through corresponding first and second external lugs 426 extending from the walls adjacent their second ends 422A, 422B. One of each pair of lugs, e.g., the second lugs, may have an internally threaded passage to engage the corresponding fastener 424A or 424B. Otherwise, mating nuts 428 may be installed upon the threaded ends of the fasteners 424A, 4246, as in the embodiments of FIGS. 16 through 18.

The square or rectangular configuration of the storage/display unit 400 of FIG. 19 may be installed upon various sizes of columns, as in the cases of the other attachments discussed further above. It will be seen that in the case of a larger central column, that the lengths of the column gripping edges 408A, 408B, 412A, and 412B do not extend along the complete span or width of each side of the column. Nonetheless, the entire length of each of the column gripping edges makes contact with such a larger column to provide secure attachment, with the facing edges of the upper and lower flange portions 404A, 404B, 406A, and 406B having gaps therebetween and necessitating longer bolts or fasteners 424A and 424B for assembling the two portions 402A and 402B to the column.

The square or rectangular embodiment 400 of FIG. 19 also includes alternative accessory attachment passages, not shown in other embodiments discussed to this point. In addition to the pegboard hook attachment holes or passages 430 shown through the second wall 418B, one portion of the first wall 418A includes a slatwall configuration having a series of horizontal slats or slots 434 formed therein while a second portion of the first wall includes a series of square or rectangular passages 436 to provide a gridwall configuration. It will be seen that these various pegboard, slatwall, and/or gridwall configurations or patterns may be provided along any portion(s) of any of the outer walls of any of the various embodiments, as desired.

FIG. 20 illustrates another embodiment of the pegboard storage unit, wherein a square or rectangular attachment 500 is secured about a round column C5. The attachment 500 is similar to the attachment 400 of FIG. 21, having upper flange portions 504A and 504B, opposite lower flange portions (not shown in FIG. 20), and walls 518A and 518B extending between the outer edges of the upper and lower flanges. The walls 518A, 518B may include a series of accessory attachment passages 530 formed therethrough, or alternative slats or gridwall receptacles, as shown in the storage/display unit embodiment 400 of FIG. 19. However, rather than having column gripping edges configured for attaching to a square or rectangular column, the storage/display unit 500 has semicircular column gripping edges 508A and 508B along the inner edges of the two respective upper flanges 504A, 504B. It will be understood that the lower flange portions are configured similarly in the embodiment of FIG. 20. Fasteners 524 are used to secure the two portions 502A and 502B together about the column C5. Rather than installing the fasteners through external lugs, as in the case of the storage/display unit 400 of FIG. 19, recesses are provided for the fasteners, similarly to the recessed fastener configuration of the first storage/display unit 100 of FIG. 16. Embossed or stamped knockouts B are depicted.

FIG. 20 also illustrates a platform 600 that may be removably installed about the column C5 to rest at least generally horizontally atop the horizontally disposed first or upper flange portions 504A and 504B of the attachment 500 immovably affixed to the column. The platform 600 comprises two separate and at least generally equal platform portions 602A and 602B that join together along their mutual diametric separation line about the column C5. Each of the portions 602A, 602B comprises a relatively thin and flat semicircular sheet or plate and includes a first surface, respectively 604A and 604B, and an opposite second surface, respectively 606A, 606B. Each of the portions 602A, 602B further includes a column gripping edge, respectively 608A and 608B, and an opposite outer periphery, respectively 610A and 610B. It should be understood that since the platform 600 is structured to rotate about the column C5, the “column gripping edges” 608A and 608B are not so tight about the column as to provide any appreciable degree of frictional resistance to such rotation, but rather retain the platform 600 about the column to limit any substantial lateral movement of the platform relative to the column. Thus, the inner edges 608A, 608B are devoid of teeth or other means of frictionally engaging the surface of the column C5.

Each of the outer peripheries 610A, 610B of the two platform portions 602A, 602B has a peripheral wall, respectively 618A and 618B, extending therefrom and at least generally normal to the plane of the platform portions. The raised periphery 618A, 618B preferably extends in only one direction from the platform, e.g., downwardly from the first surface 602A, 602B when that first surface is oriented upwardly, as shown in. FIG. 20. This provides an unbroken upper or first surface 602A, 602B for use e.g., as a writing surface, laundry ironing or folding table, etc., when the platform 600 is oriented as shown in FIG. 20. The raised peripheral wall further includes a series of accessory attachment passages 630 formed therethrough, e.g., small circular holes for the installation of pegboard hooks and the like, as shown. Alternatively, at least a portion of the periphery could be provided with slatwall slots or gridwall passages if desired, similarly to the slots 434 and gridwall passages 436 shown in the storage/display unit 400 of FIG. 19.

Various means may be used to secure the two platform portions 602A, 602B to one another. Peripheral screws or fasteners attaching through recessed or protruding lugs or passages have been illustrated for the embodiments of FIGS. 16 through 19 and discussed further above, and such attachment means may be provided for the platform of FIGS. 20 and 21, if so desired. Additional alternatives are shown in FIGS. 20 and 21, with a fastener 624 passing through a pair of lugs 626 that protrude from the second surfaces 606A, 606B of the two platform portions 602A and 602B. Another alternative is shown to the opposite side of the platform, wherein a peg or pin 638 extending from the diametric edge of the platform portion 602B mates with a receptacle 640 formed in the diametric edge of the opposite platform portion 602A. Preferably, only a single type or principle of attaching the two platform panels or portions 602A, 602B to one another would be provided with any given platform assembly.

A series of partitions 642 extend from the second surfaces 606A, 606B of the two platform portions 602A, 602B in the same direction or orientation as the peripheral walls 618A, 618B, as shown in FIGS. 20 and 21. The partitions are illustrated in various orientations, i.e., radially, as secant portions, etc., to show exemplary configurations. The various partitions 642 may be provided and oriented in any practicable number and manner desired. These partitions serve to stiffen the structure of the two platform portions 602A, 602B, but do not impede access to the opposite first surfaces 604A, 604B, as in the case of the peripheral wall portions 618A and 618B. However, if the platform portions 602A and 602B are disassembled from their orientation as shown in FIG. 20 and inverted and reassembled as shown in FIG. 20, the peripheral walls 618A, 618B and partitions 642 are oriented upwardly to define a series of compartments 644. In this configuration, the upwardly oriented compartments or bins 644 may be used to store various articles, e.g., hardware, fasteners, sewing accessories, etc., as desired. The accessory attachment passages 630 of the outer walls 618A, 618B and the corresponding passages 530 of the underlying storage/display unit device 500 may be used for the installation of various pegboard hooks, etc. for the suspension of various articles therefrom, e.g., extension cords, tools, rope and cord, etc., as desired, in addition to the storage provided by the compartments 644 of the platform assembly when it is oriented as shown in FIG. 21. In this configuration, when the interior void D of the attachment is sufficiently large, a viable and practical interior storage space is created. An integral hinged door E or drawer assembly provides access to the interior utility storage space. Optional integral top bins F on upper surface of column or post attachment are depicted.

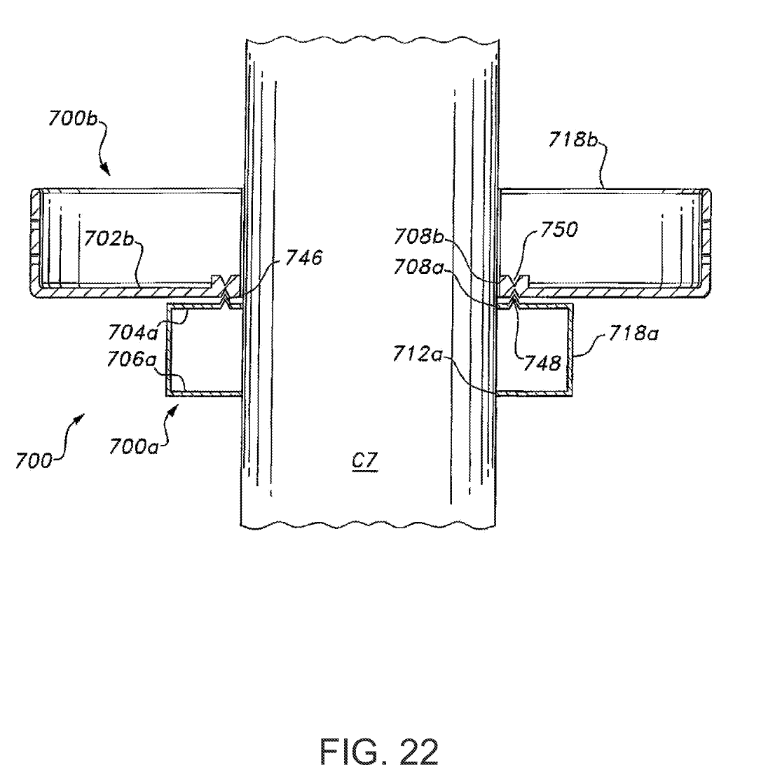

FIG. 22 is an elevation view in section of another alternative embodiment of the pegboard storage unit, comprising an assembly designated as storage/display unit 700 installed upon a column C7. In this case, rather than designating the two diametrically opposed portions of the components with the letters “A” and “B,” the components of the lower, immovably affixed structure are designated with the suffix letter “A” while the components of the upper, rotating structure are designated with the suffix letter “B” since only half of the assembly 700 is shown.

The lower, immovably affixed portion 700A comprises an immovably attached column clamp assembly having an upper flange 704A, an opposite lower flange 706A, and an outer peripheral wall 718A joining the outer edges of the two flanges. The upper and lower flanges attach to the column C7 captured therein by means of their inwardly disposed column gripping edges, respectively 708A and 712A. The lower portion 700A is thus configured much like the embodiments of FIGS. 16 through 18, but with various details omitted, such as attachment fasteners, accessory attachment passages, etc., for reasons of clarity. The upper, rotating portion 700B includes a generally horizontal platform 702B having an outer peripheral wall 718B extending therefrom and normal thereto.

The upper flange 704A of the lower component 700A includes a circumferential platform support edge 746 extending upwardly therefrom, adjacent to the column gripping edge 708A of the upper flange. The opposed first and second surfaces of the platform 702B respectively include circumferential first and second support edge engagement channels 748 and 750 formed therein, adjacent to the column gripping edge 708B of the platform. Either the first or the second channel 748 or 750 rides upon the underlying platform support edge 746 depending upon the orientation of the upper rotating component 700B, i.e., whether the wall 718B is oriented upwardly or downwardly. This provision of a platform support edge and support edge engagement channel(s) provides better alignment of the rotating component 700B during rotation, and may assist in reducing friction as the component 700B is rotated atop the underlying fixed component 700A.

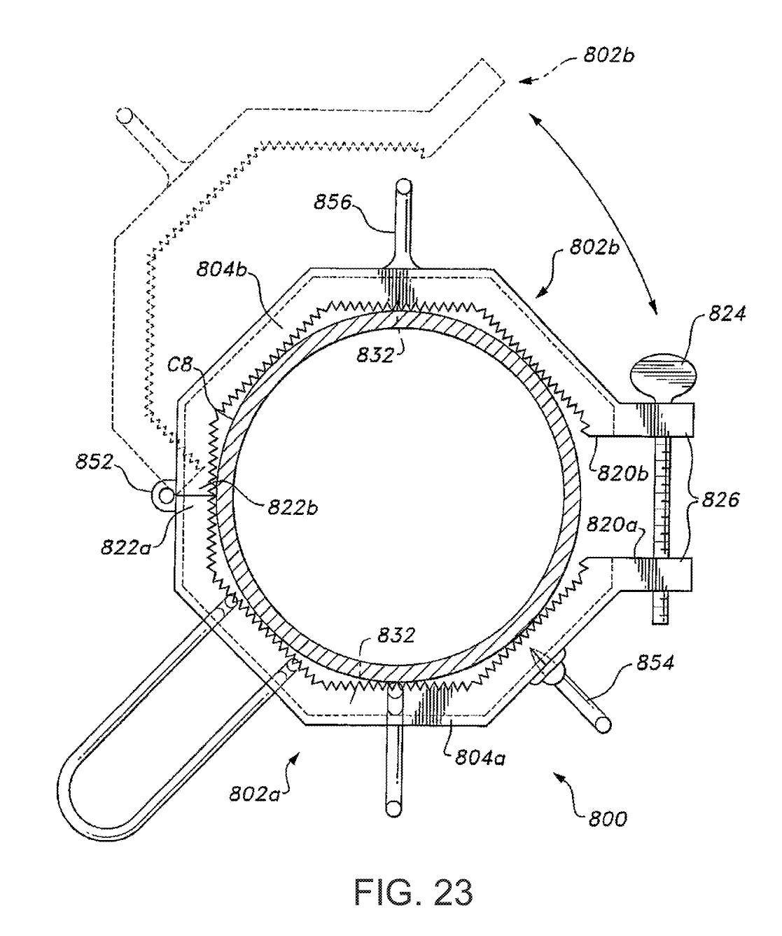

FIG. 23 is a top plan view of another embodiment incorporating a different clamping mechanism than the attachments shown in FIGS. 16 through 22 and described above. The storage/display unit 800 of FIG. 23 includes first and second clamp portions 802A and 802B each having an upper flange, respectively 804A and 804B, an opposite lower flange, not shown in FIG. 23, and outer peripheral walls 818A, 818B connecting the upper and lower flanges. The interior space defined by the upper and lower flanges and the wall portions 818A, 818B joining them together, along with the column captured therein, provides an accessory attachment end manipulating volume 832 as in the case of the other embodiments disclosed herein.

Each of the walls has a first end and an opposite second end, respectively 820A, 820B and 822A, 822B. Each of the second ends 822A and 822B includes a clamping boss or lug 826 extending therefrom, with a pinch bolt 824 adjustably secured therethrough. However, the opposite first ends 820A and 820B are secured to one another by a hinge assembly 852. The hinge assembly 852 may comprise a pintle hinge, as shown, or alternatively a live hinge formed integrally with the two wall portions 818A and 818B where they are formed of suitably flexible materials. Thus, the bolt or fastener 624 may be removed to allow the two components 802A and 802B to be swung open relative to one another about the hinge 852, as shown by the open position of the second component 802B in broken lines in FIG. 23. This allows the device to be placed about a column, e.g., column C8 of FIG. 23, and the bolt 824 to be secured through the two lugs 826 to secure the assembly about the column C8.

The storage/display unit embodiment 800 of FIG. 23 illustrates some additional features, as well. It will be seen that the planform of the storage/display unit 800 is generally octagonal, rather than the circular, rectangular, or square embodiments shown in previous drawing FIGS. It will be appreciated that any of the previously discussed embodiments 100 through 700, and others, may incorporate such an octagonal form, and/or the octagonal form of the embodiment 800 may be revised as a circular, square, or other shape as desired. Also, the storage/display unit 800 includes permanently attached accessory hangers or attachments in addition to the removable accessory attachments A. An article hanger or attachment and screw assembly 854 is attached to the wall of the first component 802A, with an integrally formed article attachment hanger 856 extending from the wall of the second component 802B. It will be seen that other hanger or attachment shapes may be provided in addition to or in lieu of those shown in FIG. 23 and/or such mechanically attached or integrally formed hangers or attachments may be provided with any of the other embodiments of the pegboard storage unit, as desired.

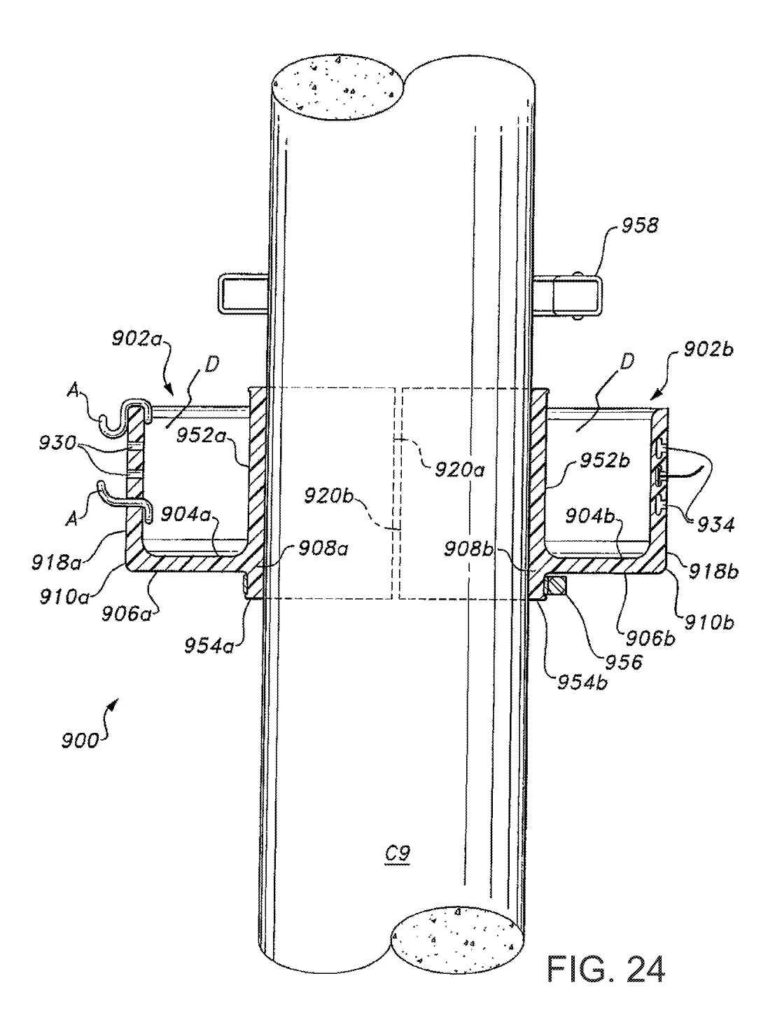

FIG. 24 is an elevation view in section of another embodiment of the pegboard storage unit, wherein each diametric half of the device is formed as a single, unitary, monolithic component comprising a walled platform, somewhat similar to the device of FIG. 21, but including an inner wall as well. The storage/display unit or platform 900 of FIG. 24 is shown somewhat like the attachment embodiment 200 of FIG. 18, i.e., one half of each portion of the device is shown.

The platform 900 comprises two separate and at least generally equal clamp or platform portions 902A and 902B that join together along their mutual diametric separation line about the column C9. Each of the portions 902A, 902B comprises a relatively thin and flat semicircular sheet or plate and includes a first surface, respectively 904A and 904B, and an opposite second surface, respectively 906A, 906B. Each of the portions 902A, 902B further includes a column gripping edge, respectively 908A and 908B, and an opposite outer periphery, respectively 910A and 910B. An outer peripheral wall 918A, 918B extends from the outer periphery 910A, 910B of each of the platform portions 902A, 902B, and generally normal thereto. The outer wall portions preferably include a plurality of accessory attachment passages therein or therethrough, e.g., pegboard hook holes 930, slatwall slots 934, etc., as desired, into which various attachments may be removably secured, e.g., the pegboard accessory attachment hooks A as shown.

A first storage/display unit sleeve portion 952A, 952B extends from the first surface 902A, 902B of the respective clamp portions or platforms adjacent to the column gripping edges thereof, with a second storage/display unit sleeve portion 954A, 954B extending from the second surfaces 904A, 904B of the respective clamp portions or platforms, directly opposite the first sleeve portions. The sleeve portions 952A through 954B are at least generally normal to the plane of the platform portions 902A and 902B. The two platform portions 902A, 902B with their outer walls 918A, 918B and first storage/display unit sleeve portions 952A, 952B define an accessory attachment end manipulating volume 932 therein when the two portions 900A, 900B are secured to a column C9 or the like, similar to that of all of the other embodiments of the storage/display unit disclosed herein.

Rather than using screws or fasteners disposed at the outer periphery of the device to secure it to the column captured therein, the embodiment of FIG. 24 uses circumferential clamps, frictional ties (such as nylon), or fasteners for pegboard storage unit. In the case of the frictional ties, no tools are required to affix storage/display unit to post or column. A conventional worm drive hose clamp 956 is secured about the lower or second storage/display unit sleeve portions 954A and 954B, with an alternative over-center clamp 958 of conventional construction being used to secure about the upper or first storage/display unit sleeve portions 952A, 952B. It will be seen that the same type of clamp, e.g., hose clamp 956, etc., may be used about both the first and second sleeve portions, and/or other types of circumferential clamps or fasteners may be applied as desired. The clamps or fasteners 956, 958 draw the sleeve portions 952A through 954B tightly up against the encircled column C9, with the ends of the platform portions, sleeve portions, and outer walls, e.g., first ends 920A and 920B, shown in broken lines in FIG. 24, being drawn closely together to form a generally continuously surrounding structure for the storage/display unit 900. It will be seen that the inner surfaces of the sleeve portions 952A through 954B may be provided with gripping teeth or otherwise roughened, generally as shown along the gripping edges 108A, 1086, 112A and 112B of the device of FIG. 16, to enhance the grip of the device to the underlying surface of the column. Periphery storage bins F, are created in this iteration of the invention.

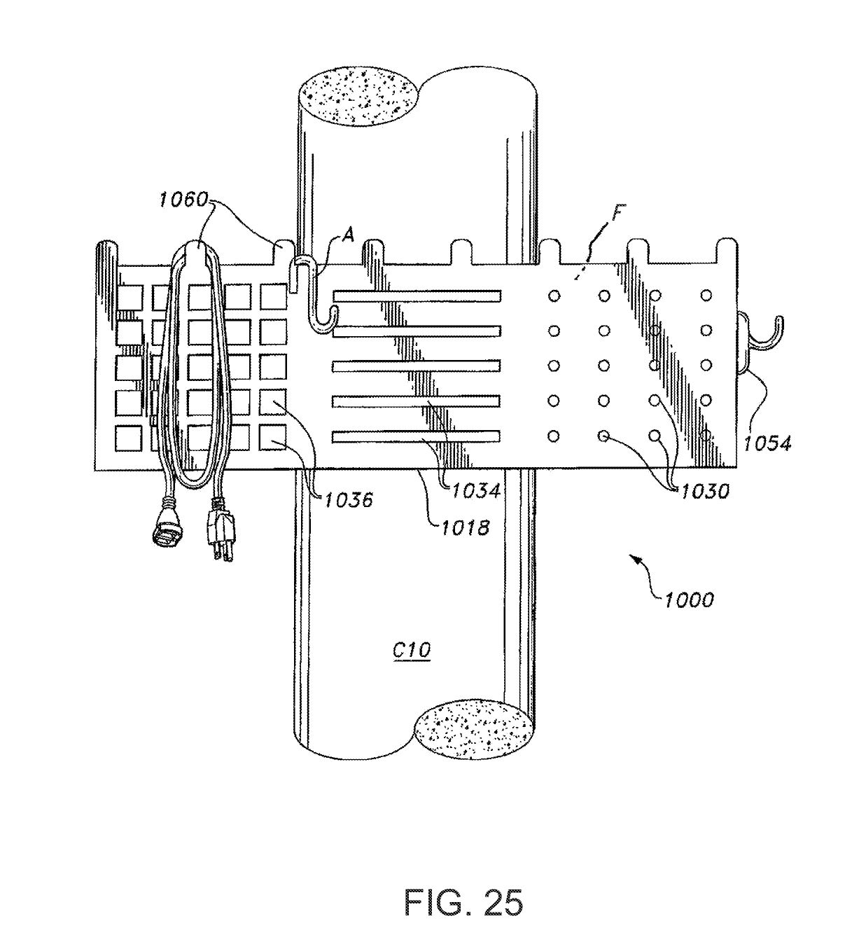

FIG. 25 illustrates an elevation view of another embodiment of the pegboard storage unit, designated as storage/display unit 1000. The storage/display unit 1000 may be formed similarly to the storage/display unit embodiments of FIGS. 16 through 19 and FIG. 23, i.e., having upper and lower flanges extending outwardly from the column C10 with an outer wall extending between the two flanges, or similarly to the embodiments of FIG. 20 through 19 and FIG. 24, i.e., having a platform with an outer wall extending therefrom. The device may utilize the peripheral fastener attachments of the pegboard storage units of FIGS. 16 through 19 and FIG. 23, or alternatively the circumferential clamp or fastener attachments of FIG. 24, as desired.

In either case, the storage/display unit 1000 includes an outer raised periphery or wall 1018, with the peripheral wall having at least one type of accessory attachment passage formed therein or therethrough, e.g., pegboard hook holes 1030, slatwall slots 1034, gridwall passages 1036, etc. as desired. The wall 1018 further includes a series of raised projections 1060 disposed along the raised peripheral wall 1018. The raised projections 1060 provide additional temporary attachment means for articles such as extension cords, rope and cord, etc., as desired. Accessory attachments such as the pegboard attachment A may be suspended from the upper edge of the raised peripheral wall 1018, if so desired, in addition to using the pegboard passages 1030. Moreover, other means of attaching the attachments or hooks may be used, e.g., a screw or mechanical fastener attached hook 1054 or integrally formed hook or accessory attachment, similar to the devices 854 and 856 shown with the embodiment 800 of FIG. 23. Peripheral storage bins F are also created between the outer and inner edges of the post attachment.

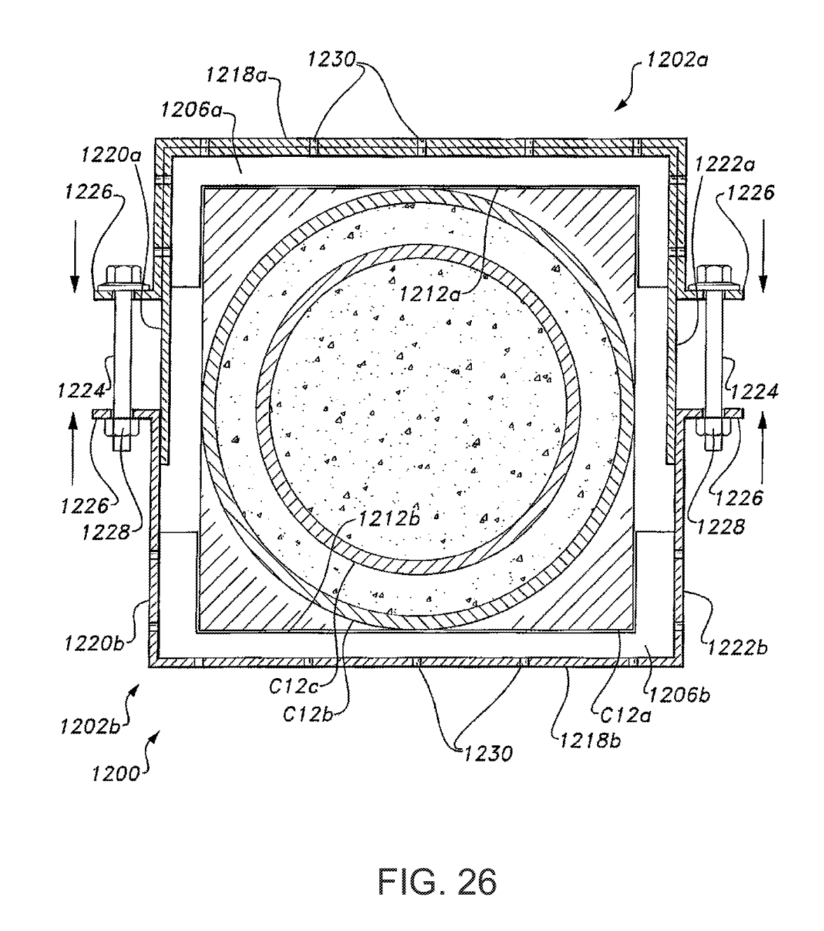

FIG. 26 provides a perspective view of another embodiment of the pegboard storage unit, similar to the assemblies illustrated in FIGS. 21 and 22. In this case, the components of the lower, immovably affixed assembly are designated with the numerals between 1100 and 1150, while the components of the upper assembly are designated by numerals from 1150 up to but not including 1200.

The lower, immovably affixed assembly 1100 comprises separable first and second portions 1102A and 1102B, each of which includes an upper flange, respectively 1104A and 1104B, an opposite lower flange (not shown in FIG. 26, but similar to the lower flange components shown in other drawings for other embodiments), and an outer peripheral wall, respectively 1118A and 1118B, joining the outer edges of the two flanges. The upper and lower flanges attach to the column C11 captured therein by means of their inwardly disposed column gripping edges, e.g., lower edges 1108A and 1108B.

The assembly comprising the lower portions 1102A and 1102B is thus configured much like the embodiments of FIG. 16 through 19, but with various details, such as attachment fasteners, etc., omitted for clarity. Also, while the lower assembly 1100 is shown as having a hexagonal configuration, it will be seen that the external shape may be configured to any practicable shape as desired, just as in the cases of the other embodiments described herein. The upper flange portions 1104A, 1104B of the lower components 1102A, 1102B include a circumferential platform support edge 1146 extending upwardly therefrom, adjacent to the column gripping edges 1108A, 1108B of the upper flanges. The upper, rotating portion 1150 rests upon this support edge, as explained below.

The upper, rotating portion 1150 includes generally horizontal first and second platform components 1152A and 1152B each having an outer peripheral wall, respectively 1158A and 1158B, extending therefrom and normal thereto. The opposed first and second surfaces 1154A through 1156B of the platform assembly 1150 respectively include circumferential first and second support edge engagement channels formed therein, adjacent to the column gripping edges 1158A, 1158B of the platform. While only the first support edge engagement channel 1198 is shown in FIG. 26, it will be understood that the configuration incorporating two opposed support edge engagement channels is quite similar to that illustrated in FIG. 22 and discussed further above. Either the first or the second channel rides upon the underlying platform support edge 1146 depending upon the orientation of the upper rotating component 1150, i.e., whether the walls 1158A, 1158B are oriented upwardly or downwardly. This provision of a platform support edge and support edge engagement channel(s) provides better alignment of the rotating component 1150 during rotation, and may assist in reducing friction as the component 1150 is rotated atop the underlying fixed component 1100.

The storage/display unit assembly 1100, 1150 of FIG. 26 includes various additional features as well. It will be noted that the lower, immovably affixed attachment 1100 may include various accessory attachment passages, e.g., pegboard attachment holes 1130, slatwall slots 1134, or a rectilinear series of gridwall passages 1136, as desired. The pattern illustrated in FIG. 26 is exemplary, and may be revised as desired. In addition, the upper rotary platform assembly 1150 includes various features, e.g., one or more partitions 1192 dividing the interior space between the walls into a series of separate compartments 1194, and/or one or more tool receptacles 1195 for holding various tools, e.g., hammers, screwdrivers, pliers, etc., therein. Moreover, the underlying second surfaces 1156A, 1156B may include lights 1199 attached thereto, e.g., battery powered “puck” lights having a relatively compact and low, circular configuration, or other type(s) of lighting as desired. The provision of tool receptacles and lighting, as well as other features shown in the embodiment of FIG. 26, may be incorporated with other embodiments described herein as well. Tool receptacles 1195, as well as other features may be incorporated into post attachment should secondary attachment not be utilized.

FIG. 26 is a top plan view in section of another embodiment of the pegboard storage unit, designated as storage/display unit 1200. The storage/display unit 1200 includes generally opposed, first and second portions 1202A and 1202B each having three sides forming a rectilinear shape. The two portions 1202A, 1202B each include an upper flange, not shown in FIG. 26, but similar to e.g., the upper flange portions 404A, 404B of the embodiment of FIGS. 19 and 504A, 504B of the embodiment of FIG. 20, and opposite lower flange, respectively 1206A and 1206B, with the flange components being connected at their outer edges by a rectilinear wall structure comprising wall portions 1218A and 1218B. Each of the wall portions includes a straight central portion with first end portions, respectively 1220A and 1220B, and opposite second end portions, respectively 1222A and 1222B, extending therefrom. The walls 1218A, 1218B are provided with a series of accessory attachment passages 1230, and/or other configuration, therethrough, in the manner of the other embodiments disclosed herein. The interior space defined by the upper and lower flanges and the wall portions 1218A, 1218B joining them together, along with the column captured therein, provides an accessory attachment end manipulating volume 1232 as in the case of the other embodiments disclosed herein.

The first and second end portions 1220A through 1222B of the walls include corresponding first and second external lugs 1226 extending therefrom. Corresponding first and second fasteners 1224 pass through these lugs, with retaining nuts 1228 installed at one end of each of the fasteners. Alternatively, one lug on each side may be internally threaded to allow the threaded fastener to secure directly therein. Tightening the fasteners 1224 draws the inwardly disposed first wall end portions 1220A and 1222A to slide or telescope within the outwardly disposed second wall end portions 120B and 1222B, thereby drawing the two parallel mid-portions of the walls up against the sides of the column captured therein. Additional security may be provided by gripping teeth, not shown in FIG. 26, but similar to the teeth 116 shown in FIG. 16, etc., disposed along the column gripping edges 1212A and 1212B of the lower flange portions 1206A, 1206B and corresponding upper flange portions. It will be seen that the storage/display unit 1200 is capable of being installed upon a wide variety of different column configurations, e.g., the square column C12A, larger diameter round column C12B, or smaller diameter round column C12C, as well as others.

A number of different features and attachments may be included with the storage/display unit 1200 of FIG. 26, as desired. For example, a platform may be installed thereon, such as the platforms 600 of FIGS. 20 and 21 and 700B of FIG. 22. Such a platform may include a raised periphery with various accessory attachment passages therein, permanently fastened accessory attachments extending therefrom, raised projections extending from the edge of the periphery, one or more partitions extending within or across the raised periphery to define a series of compartments therein, one or more tool storage receptacles and/or lighting as in the platform 1150 of FIG. 26, etc., as desired.

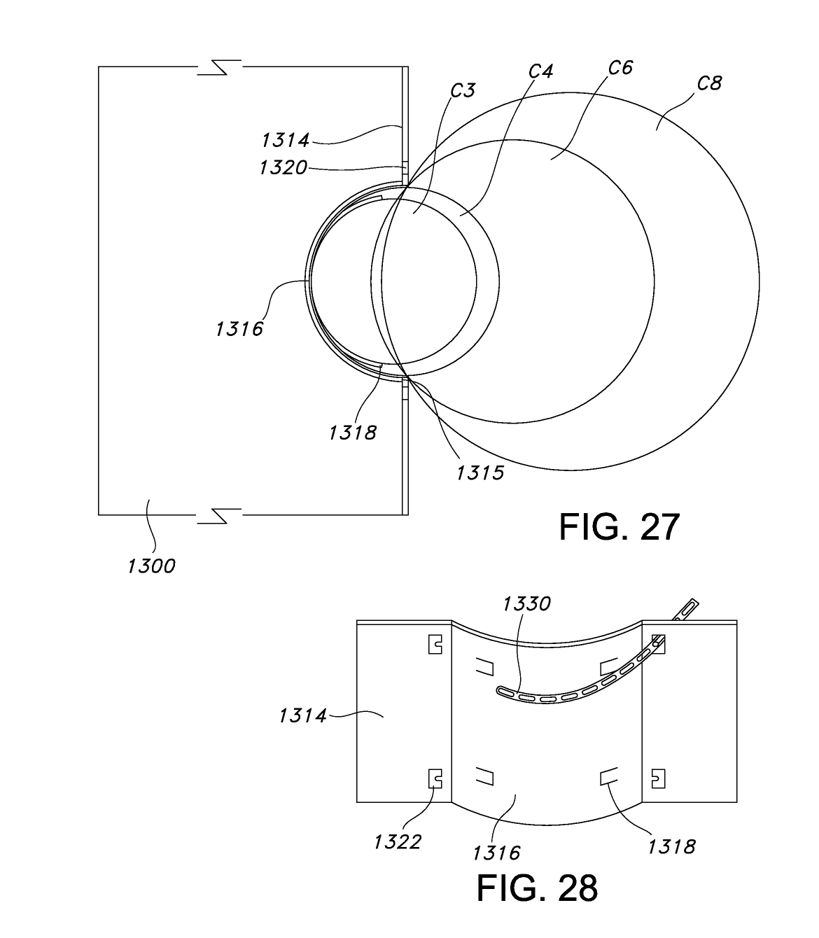

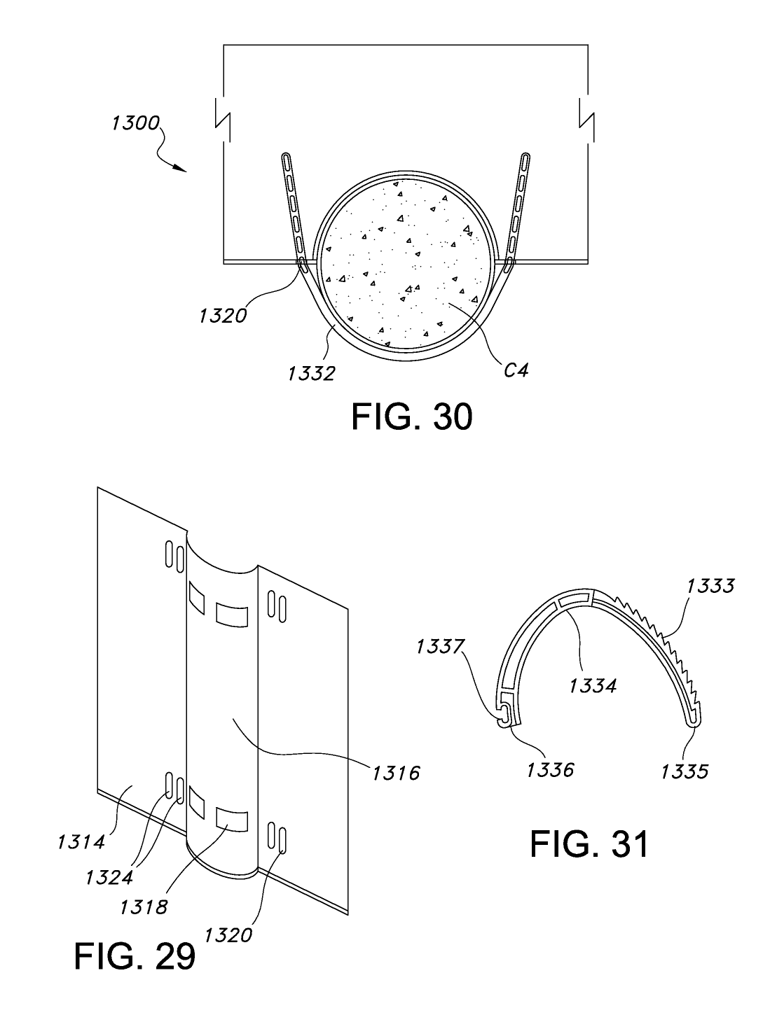

FIGS. 27-30 illustrate another embodiment 1300 of a storage/display unit according to the invention, one that mounts only on a portion of the circumference of a support column C. The storage/display unit 1300 may be similar in construction to any of the embodiments shown in FIGS. 1-13, with regard to features of the construction relating to the side walls 1-14, the wall connectors 1-18, the access means 1-30 and the interior storage area 1-12. The storage/display unit 1300, however, has a rear panel 1314 with a column adapter 1316 that is adaptable to the various curvatures of support columns C. Details of the rear panel 1314 are shown in FIG. 29. The rear panel 1314 is preferably molded as a single piece from a thermoplastic material. Compression means 1318 provided on the column adapter 1316 allow the storage/display unit 1300 to be mounted on a column with a smaller diameter than the curvature of the column adapter 1316. Strap-mounting means 1320 are provided to secure the storage/display unit 1300 to the column C. The strap mounting means 1320 includes apertures in the rear panel 1314 that are adapted to receive and hold some strap or bracket means 1320, as shown in FIGS. 28-30.

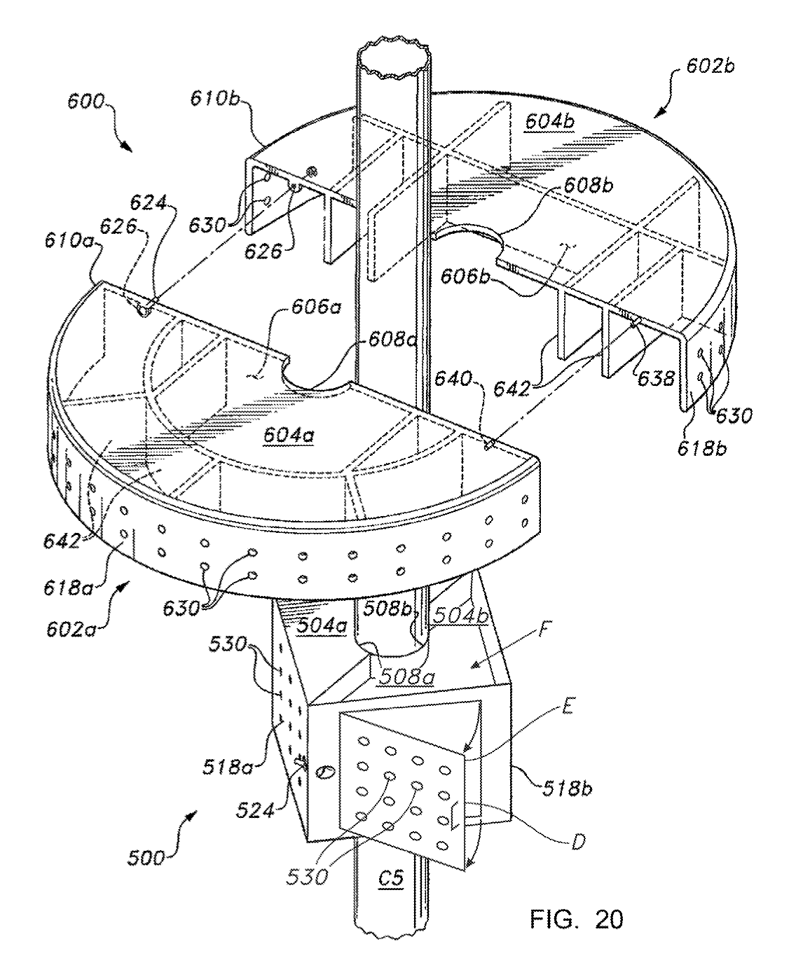

FIG. 27 illustrates how the storage/display unit 1300 may be mounted on a column three and one-half inches in diameter, C3, a column four inches in diameter, C4, a column six inches in diameter, C6, and a column eight inches in diameter, C8. In the embodiment shown, the column adapter 1316 is constructed to fit snugly against the four-inch column C4. When mounted on the three-and-one-half inch column C3, the adapter tabs 1318 spring forward and serves as a compression means to provide a force against the column C3. When mounted on the six-inch or the eight-inch column, C6,C8, only an inner edge 1315 of the rear panel 1314 has contact with the respective column. In all four cases, the mounting means 1320 serves to selectively secure the storage/display unit 1300 to the columns C3, C4, C6, and C8. FIG. 30 shows the storage/display unit 1300 secured against a four-inch column C4.

FIG. 28 illustrates a first configuration of the mounting means 1320, which includes a catch 1322 in the rear panel 1314 and a belt or strap 1332 with a series of holes or recesses in it. The catch 1322 shown in this embodiment is an aperture a finger or hook projecting into the aperture. One catch 1322 is provided on each side of the column adapter 1316. Ideally, the belt is a rubber or plastic belt with some stretch to it. The belt 1332 is pulled through the two apertures 1322 and pulled tight, whereby the finger in the aperture 1322 snaps into the hole in the belt 1332.

FIG. 29 illustrates a second configuration of the mounting means 1320, which includes one or more apertures 1324 on each side of the column adapter 1316, and a toothed bracket 1334 that snaps into the apertures 1324. In the embodiment shown, a hook 1337 or a series of ridges or teeth 1333 may be provided on a second end 1336 of the bracket 1334 and a series of ridges or teeth 1336 on a first end 1335. The second end is secured in the an aperture 1324 on one side of the column adapter 1316 and the first end 1335 pushed into one of the apertures 1324 on the other side of the adapter 1316, until the storage/display unit 1300 is held securely against the respective column C3, C4, C6, or C8. The ridges teeth 1336 and/or hook 1337 prevent the bracket 1334 from inadvertently slipping out of the aperture 1324. The bracket 1334 may be removed from the storage/display unit 1300 simply by pushing the distal end of the first end 1336 in toward the respective column, which allows the first end to slip out of the aperture 1324. The second end may then also be removed from the structure.

The above described mounting means 1320 are merely examples of suitable means for securing the storage/display unit 1300 against the column C. It is understood that many different means may be used in conjunction with the storage/display unit 1300 that has the rear panel 1314 with the column adapter 1316.

FIGS. 27-29 also illustrate compression means 1316 that may be provided on the rear wall 1314, to further enhance the adaptability of the storage/display unit 1300 to various sizes of support columns C. One possible compression means 1318 may comprise ears or tabs, that are stamped out of the molded plastic material of the column adapter 1316. Because of the molded curvature of this material, the ears 1318 will automatically tend to curve into the curve more so than the surrounding material, thereby providing a compression force against the column C, when the storage/display unit is secured in place. These ears may be provided with a live hinge, allowing the tabs to be folded back into the curved contour of the column adapter 1316. In this case, when the storage/display unit 1300 is mounted on the support column C, the ears or tabs 1316 are first folded back into the curved contour of the rear wall. The live hinge 1316H also serves as a biasing spring, so that the ears 1316 apply pressure to the support column C. Another possible embodiment of the compression means 1316 may be compressible pads that are affixed to the outer surface of the column adapter 1316. Ideally, these compressible pads are constructed of a material that has some anti-slip properties.

An alternative embodiment of the storage/display unit 1300 has a partial rear wall 1314, without the column adapter 1316. With this embodiment, the rear wall 1314 is fitted up against the column C, similarly to how the storage/display unit 1300 is shown in FIG. 27 as fitted against columns C6 and C8. The inner edge 1315 is pressed up against the column C and the storage/display unit secured by the various embodiments of the strap mounting means 1320 described above.

Collapsible plastic crates have become very popular in recent years. Such crates have an open top, four sides, and a bottom. Crates, such as those disclosed in U.S. Pat. Nos. 4,811,968 and 4,824,137, typically have two opposing sides constructed as hinged panels that fold in the manner of an accordion pleat, and the other two opposing sides constructed as swing panels that swing from a top edge into the center space of the crate. By swinging in the two swing panels, the other two side panels may be folded down, thereby achieving a collapsed, flat package. Other collapsible plastic crates, such as those disclosed in U.S. Pat. Nos. 7,717,283 B2 and 7,478,726 B2, have two opposing side panels that removably snap into the bottom panel and the two other side panels that fold down over the bottom panel. The two side panels may be unsnapped from the bottom wall and the two other side panels folded down over the bottom wall, with the two unsnapped panels placed on top, to achieve a flat package. These four patents are incorporated in their entirety herein by reference. These constructions allow the crate to be folded and/or disassembled, so as to provide a compact, relatively flat package for stowing away when not in use or for shipping purposes. A person of skill in the art will understand that the storage/display unit 1300 of the present application may be constructed in the manner of these collapsible crates. In such an embodiment, the rear wall 1314 with column adapter 1316 may be attached to the side-wall edges that bound the open face of the collapsible crate. The conventional bottom wall of the collapsible crate may be adapted as a side wall 1-14S with access means 1-30, all as described above. All of the side walls of the collapsible crates may be apertured walls 1-16 as described above. The storage/display unit 1300 is then a collapsible structure that may be folded and/or disassembled to become a flat package for stowing away or shipping.

It is understood that the embodiments described herein are merely illustrative of the present invention. Variations in the construction of the storage/display unit may be contemplated by one skilled in the art without limiting the intended scope of the invention herein disclosed and as defined by the following claims.

What is claimed is:

1: A storage/display unit having an enclosed structure that provides an exterior storage space and an interior storage space, the storage/display unit comprising:
a plurality of walls assemblable to the enclosed structure, wherein at least one wall is constructed of an apertured wall that has one or more apertures for receiving an item-mount device that is a conventional pegboard or slatboard accessory and wherein the item-mount device is selectively insertable into the one or more apertures on the exterior storage area and on the interior storage area;
an access means for accessing the interior storage area; and
a means for mounting the enclosed structure on a support;
wherein the enclosed structure is mountable on a column.

2: The storage/display unit of claim 1, wherein the plurality of walls includes four vertical walls and two horizontal walls, so as to form the enclosed structure that is rectangular in shape.

3: The storage/display unit of claim 1, wherein the plurality of walls are constructed on a unitary sheet, and wherein the unitary sheet is foldable so as to form the enclosed structure with side walls, a top wall, and a bottom wall.

4: The storage/display unit of claim 1, wherein the top wall and the bottom wall are circular and the side walls are formed on a unitary sheet, wherein one end of the unitary sheet is fastenable to the other to form a circular side wall that is attachable to the top wall and bottom wall, so as to form the enclosed structure that is cylindrical in shape.

5: The storage/display unit of claim 1, wherein the enclosed structure comprises two halves, each half including side walls, a top wall and a bottom wall, wherein the two halves have mating female-male edges such that mating edges of a first half fit inside mating edges of a second half.

6: The storage/display unit of claim 5, further comprising a clamp device for clamping the two halves together, the side walls including apertured walls made of pegboard and the clamp device being insertable into a peg aperture on the first half and into a peg aperture on the second half.

7: The storage/display unit of claim 1, wherein the connection means are provided along the edges of each wall of the plurality of walls so as to provide a fastener connection between any two adjacent walls.

8: The storage/display unit of claim 7, wherein the connection means is a mating ribbed connector that includes a ribbed male projection and a ribbed female receiver adapted for receiving the ribbed male projection, and wherein the walls have two opposing edges with the ribbed male projection along a first edge and the ribbed female connection along a second edge.

9: The storage/display unit of claim 1, further comprising a column mounting means in the top wall and the bottom wall, the column mounting means having a column opening that is dimensioned to fit about the perimeter of a support column and an assembly opening that allows the top wall and the bottom wall to be assembled onto the side walls about the support column.

10: The storage/display unit of claim 9, the column mounting means including a locking means for securing the top wall and the bottom wall against the support column.

11: The storage/display unit of claim 10, wherein the assembly opening has edges with receiving grooves and the locking means is a slide lock that is slidingly captured in the receiving grooves, the receiving grooves and edges of the slide lock having ridges such that, when the slide lock is assembled in the column mounting means, the ridges in the grooves and on the slide lock cooperate to prevent the slide lock from inadvertently sliding out of a lock position.

12: The storage/display unit of claims 10, wherein the column mounting means includes a friction gripping means for preventing the enclosed storage from slipping on the support column.

13: The storage/display unit of claim 12, wherein the gripping means is a friction lip of flexible material.

14: The storage/display unit of claim 1, further comprising reinforcing ribs on the apertured wall in an area where apertures are provided, so as to reinforce the edges of the apertures.

15: The storage/display unit of claim 1, wherein at least a portion of the apertured wall is constructed of pegboard.

16: The storage/display unit of claim 1, wherein at least a portion of the apertured wall is constructed of slatboard.

17: The storage/display unit of claim 1, wherein the access means is an opening in one of the walls.

18: The storage/display unit of claim 1, wherein the access means is a door.

19: The storage/display unit of claim 1, further comprising a knockout section in the top wall and in the bottom wall, the knockout being selectively removable, as needed, to adapt the column mounting means to additional sizes and shapes of the support column.

20: A storage/display unit having an enclosed structure that provides an exterior storage space and an interior storage space, the storage/display unit comprising:
a plurality of walls assemblable to the enclosed structure, one of the walls being a rear wall that includes a mounting means for mounting the enclosed structure on a round support column.

21: The storage/display unit of claim 20, wherein the rear wall includes a column adapter that has a rounded contour for fitting against a round support column.

22: The storage/display unit of claim 21, wherein the column adapter is adaptable to fit onto various sizes of the round support column.

23: The storage/display unit of claim 22, wherein the column adapter has a curvature corresponding to a first diameter and wherein the column adapter includes a compression means that enables the column adapter to fit against a column with a smaller diameter than the first diameter.

24: The storage/display unit of claim 20, wherein the mounting means includes a strap means and apertures in the rear wall for receiving the strap.

25: The storage/display unit of claim 20, the rear wall being a partial rear wall with an open central portion, the rear wall connected on two outer edges to a corresponding edge of a side wall, the rear wall having two inner edges that bound the open central portion, wherein the two inner edges are fitted up against the round support column, and wherein the enclosed structure is securable against the round support column with the mounting means.
